(19) United States
(12) Patent Application Publication
(10) Pub. No.: US 2025/0139772 A1
(43) Pub. Date: May 1, 2025

(54) INFORMATION PROCESSING APPARATUS, BIOLOGICAL SAMPLE OBSERVATION SYSTEM, AND IMAGE GENERATION METHOD

(71) Applicant: SONY GROUP CORPORATION, TOKYO (JP)

(72) Inventors: KENJI IKEDA, TOKYO (JP); KATSUHISA SHINMEI, TOKYO (JP); TETSURO KUWAYAMA, TOKYO (JP); KAZUHIRO NAKAGAWA, TOKYO (JP)

(21) Appl. No.: 18/834,358

(22) PCT Filed: Jan. 25, 2023
(86) PCT No.: PCT/JP2023/002215

§ 371 Date: Jul. 30, 2024

(30) Foreign Application Priority Data
Feb. 7, 2022 (JP) 2022-017079

(51) Int. Cl. G06T 7/00; G06T 5/50; G06T 5/70

(52) U.S. Cl. CPC G06T 7/0012; G06T 5/50; G06T 5/70; G06T 2207/20182; G06T 2207/20192; G06T 2207/20221; G06T 2207/20224; G06T 2207/30096

(57) ABSTRACT

An information processing apparatus (100) according to one embodiment of the present disclosure includes a guide image generation unit (133) configured to sum up a plurality of images each including spectral information regarding a biomarker, and perform a division on a result by a number of summed images to generate a guide image for correction.

### FIELD

The present disclosure relates to an information processing apparatus, a biological sample observation system, and an image generation method.

### BACKGROUND

For example, in some cases, a color-separated image in multiplexed fluorescence images has low signal intensity, which can lead to being obscured or buried in the background (resulting in low S/N), depending on the types of dye or antibody involved. This may cause difficulty in understanding from a biological point of view. As an example, CD3, CD5, and CD7 are all markers expressed in the T cell region, but depending on the combination with the dye, S/N may become low for some markers.

In this regard, for example, to remove noise from a processing-target image, Patent Literature 1 discloses a technique that uses a tomographic image before drug administration or a tomographic image subjected to noise removal processing as a guidance image, thus performing noise removal processing on the processing-target image using a guided filter.

### CITATION LIST

### Patent Literature

Patent Literature 1: JP 2019-113475 A

### SUMMARY

### Technical Problem

However, due to the mechanism of the color separation algorithm (spectral color separation), the acquired signals are divided by coefficients based on the spectrum. In cases where the spectral shapes are similar, or the signals are inherently small, a color-separated image with a low S/N (signal-to-noise ratio) will be obtained. Furthermore, even if the obtained image undergoes noise removal (NR) processing with a general isotropic filter, it could smooth out even the signals necessary for subsequent cell analysis. Thus, there is a demand for a technique that can retain the necessary signal intensity for analysis, such as cell analysis, while extracting a necessary signal obscured or buried in the background of the processing-target image. This requirement applies not only to color-separated images but also to other processing-target images.

Thus, the present disclosure provides an information processing apparatus, a biological sample observation system, and an image generation method capable of acquiring a necessary signal obscured or buried in the background of a processing-target image while maintaining the signal intensity necessary for analysis.

### Solution to Problem

An information processing apparatus according to the embodiment of the present disclosure includes: a guide image generation unit configured to sum up a plurality of images each including spectral information regarding a biomarker, and perform a division on a result by a number of summed images to generate a guide image for correction.

A biological sample observation system according to the embodiment of the present disclosure includes: an image-capturing device configured to acquire a plurality of images each including spectral information regarding a biomarker; and an information processing apparatus configured to process the plurality of images, wherein the information processing apparatus includes a guide image generation unit configured to sum up the plurality of images and perform a division on a result by a number of summed images to generate a guide image for correction.

An image generation method according to the embodiment of the present disclosure includes: summing up a plurality of images each including spectral information regarding a biomarker, and performing a division on a result by a number of summed images to generate a guide image for correction.

### BRIEF DESCRIPTION OF DRAWINGS

FIG. 1 is a diagram illustrated to describe major technical details according to the present disclosure.

FIG. 2 is a diagram illustrating an exemplary schematic configuration of an information processing system according to an embodiment of the present disclosure.

FIG. 3 is a flowchart illustrating an example of the basic processing procedure of an information processing apparatus according to an embodiment of the present disclosure.

FIG. 4 is a diagram illustrating an exemplary schematic configuration of an analysis unit according to an embodiment of the present disclosure.

FIG. 5 is a diagram illustrated to describe an example of a method of generating a concatenated fluorescence spectrum according to an embodiment of the present disclosure.

FIG. 6 is a flowchart illustrating the procedure of a first processing example of NR correction using a guide image according to an embodiment of the present disclosure.

FIG. 7 is a diagram illustrating a color map for each sigma (Sigma) in the first processing example according to an embodiment of the present disclosure.

FIG. 8 is a flowchart illustrating the procedure of a modification of the first processing example according to an embodiment of the present disclosure.

FIG. 9 is a flowchart illustrating the procedure of a second processing example of NR correction using a guide image according to an embodiment of the present disclosure.

FIG. 10 is a diagram illustrating a color map for each sigma (Sigma) in the second processing example according to an embodiment of the present disclosure.

FIG. 11 is a diagram illustrating the benefits of the second processing example in actual cell analysis according to an embodiment of the present disclosure.

FIG. 12 is a flowchart illustrating the procedure of a third processing example of NR correction using a guide image according to an embodiment of the present disclosure.

FIG. 13 is a diagram illustrating an example of a histogram of a stained fluorescent component image and an unstained fluorescent component image according to an embodiment of the present disclosure.

FIG. 14 is a flowchart illustrating the procedure of a fourth processing example of NR correction using a guide image according to an embodiment of the present disclosure.

FIG. 15 is a diagram illustrating an example of image processing according to an embodiment of the present disclosure.

FIG. 16 is a diagram illustrating an example of image processing according to an embodiment of the present disclosure.

FIG. 17 is a flowchart illustrating the procedure of a fifth processing example of NR correction using a guide image according to an embodiment of the present disclosure.

FIG. 18 is a flowchart illustrating the procedure of a sixth processing example of NR correction using a guide image according to an embodiment of the present disclosure.

FIG. 19 is a flowchart illustrating the procedure of a seventh processing example of NR correction using a guide image according to an embodiment of the present disclosure.

FIG. 20 is a flowchart illustrating the procedure of an eighth processing example of NR correction using a guide image according to an embodiment of the present disclosure.

FIG. 21 is a flowchart illustrating the procedure of a ninth processing example of NR correction using a guide image according to an embodiment of the present disclosure.

FIG. 22 is a flowchart illustrating the procedure of a tenth processing example of NR correction using a guide image according to an embodiment of the present disclosure.

FIG. 23 is a diagram illustrating an exemplary schematic configuration of a fluorescence observation apparatus.

FIG. 24 is a diagram illustrating an exemplary schematic configuration of an observation unit.

FIG. 25 is a diagram illustrating an example of a sample.

FIG. 26 is an enlarged view of a region where the sample is irradiated with line illumination.

FIG. 27 is a diagram schematically illustrating the overall configuration of the microscope system.

FIG. 28 is a diagram illustrating an example of an image-capturing method.

FIG. 29 is a diagram illustrating an example of an image-capturing method.

FIG. 30 is a diagram illustrating an example of a schematic hardware configuration of the information processing apparatus.

### DESCRIPTION OF EMBODIMENTS

Embodiments of the present disclosure are now described in detail with reference to the drawings. Moreover, the present embodiments do not limit the apparatus, system, method, and the like according to the present disclosure. Further, in the specification and the drawings, components having substantially the same functional configuration are designated by basically the same reference numerals, so redundant description will be omitted.

One or more embodiments described herein can each be implemented independently. On the other hand, at least a portion of the plurality of embodiments described herein can be implemented in combination with at least a portion of other embodiments as appropriate. These multiple embodiments may include novel features that are different from each other. Thus, these multiple embodiments can contribute to solving mutually different objectives or challenges and can produce mutually different effects.

The present disclosure is now described in accordance with the order of items illustrated below.
1. Introduction
2. Embodiments
2-1. Configuration example of information processing system
2-2. Basic processing example of information processing apparatus
2-3. Processing example of fluorescence separation
2-4. Processing examples of NR correction using guide image
2-4-1. First processing example
2-4-2. Second processing example
2-4-3. Third processing example
2-4-4. Fourth processing example
2-4-5. Fifth processing example
2-4-6. Sixth processing example
2-4-7. Seventh processing example
2-4-8. Eighth processing example
2-4-9. Ninth processing example
2-4-10. Tenth processing example
2-5. Operation and Effect
3. Other embodiments
4. Application example
5. Application example
6. Hardware configuration example
7. Additional notes

### 1. INTRODUCTION

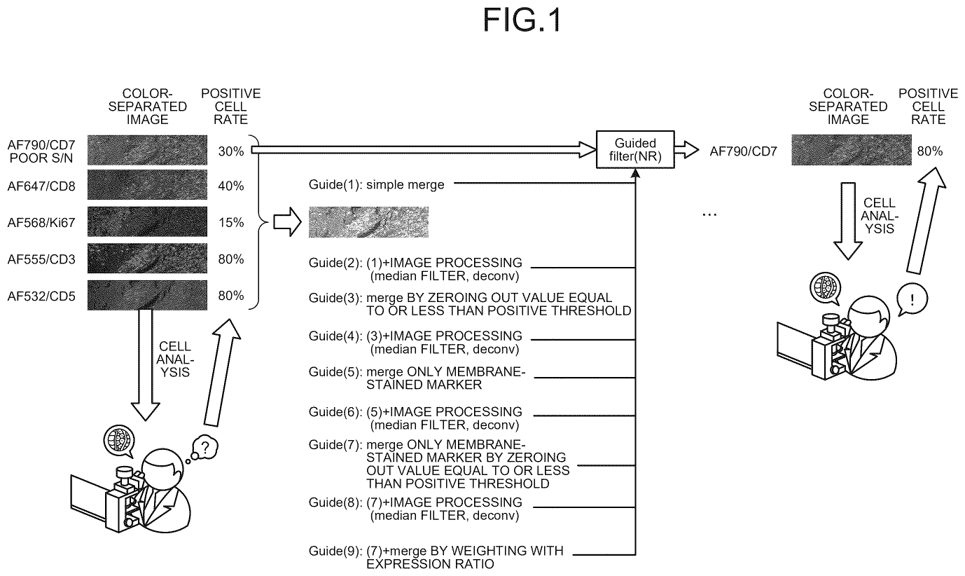

The major technical details according to the present disclosure are now described with reference to FIG. 1. FIG. 1 is a diagram illustrated to describe major technical details according to the present disclosure.

As illustrated in FIG. 1, the major technical details of the present disclosure relate to an image processing technology that applies an NR (noise removal: guided filter) technology using a guide image (Guide) as a filter to make the percentage of positive cells obtained through cell analysis more reliable. In this image processing technology, a plurality of multispectral images (e.g., color-separated images) are merged (summed) and the result is divided by the number of merged images to generate a guide image, and NR correction is performed on the multispectral images using the created guide image. In the example of FIG. 1, the guide images have nine types, ranging from Guide (1) to Guide (9). Moreover, merging refers to summing up the signal intensity values (e.g., luminance values or pixel values) of the respective multispectral images for pixel by pixel.

Guide (1) is an image obtained by performing simple merging on a plurality of multispectral images. Guide (2) is an image obtained by performing image processing (e.g., median filter, deconv) on the image of Guide (1). Guide (3) is an image obtained by merging a plurality of multispectral images with a value equal to or less than the positive threshold that is set to zero. Guide (4) is an image obtained by performing image processing (e.g., median filter, deconv) on the image of Guide (3). Guide (5) is an image obtained by merging a plurality of multispectral images corresponding only to a membrane-stained marker. Guide (6) is an image obtained by performing image processing (e.g., median filter, deconv) on the image of Guide (5). Guide (7) is an image obtained by merging a plurality of multispectral images corresponding only to the membrane-stained marker, with a value equal to or less than a positive threshold set to zero. Guide (8) is an image obtained by performing image processing (e.g., median filter, deconv) on the image of Guide (7). Guide (9) is an image obtained by weighting the image of Guide (7) with the expression ratio.

Generation processing of the guide images such as Guides (1) to (9), Correction processing using the guide images, or the like will be described in detail in later embodiments, but the guide images are ones functioning as the guide image used for NR correction of the multispectral images. For example, due to the characteristics of spectral color separation, it is challenging to obtain a color-separated image with low S/N in a case where the spectral shapes are similar or the acquired signal is inherently small. To solve this challenge, a high S/N image is used as the guide image, and NR correction is applied, thus allowing for the restoration of a necessary signal obscured or buried in the background without weakening the signal intensity required for cell analysis. For example, a guide image with a high S/N ratio can be prepared, and a signal only from spatially correlated positions between the guide image and an NR target image can be retained, while smoothing the rest. This allows for the retention of a signal necessary for cell analysis while eliminating just unnecessary background signals. Additionally, a result that is describable from a biological perspective can be obtained. As a result, this can lead to improved diagnostic accuracy. Furthermore, it is possible to correct an NR target image with low S/N, based on a guide image created with the same cell type (e.g., a marker specifically expressed in the T cell region). Thus, using a guide image created with a marker expressed in a specific cell type makes it possible to improve the result of cell analysis limited to the concerned cell type.

### 2. EMBODIMENTS

### 2-1. Configuration Example of Information Processing System

An exemplary configuration of an information processing system according to the present embodiment is described with reference to FIG. 1. FIG. 1 is a diagram illustrating an exemplary schematic configuration of an information processing system according to the present embodiment. The information processing system is an example of a biological sample observation system.

As illustrated in FIG. 1, the information processing system according to the present embodiment includes an information processing apparatus 100 and a database 200. Inputs to the information processing system include a fluorescent reagent 10A, a specimen 20A, and a fluorescent-stained specimen 30A.

### (Fluorescent Reagent 10A)

The fluorescent reagent 10A is a chemical used to stain the specimen 20A. The fluorescent reagent 10A is, for example, a fluorescent antibody, a fluorescent probe, or a nuclear staining reagent, but the type of the fluorescent reagent 10A is not limited to these particular ones. Examples of fluorescent antibodies include a primary antibody used for direct labeling or a secondary antibody used for indirect labeling. Additionally, the fluorescent reagent 10A is managed with identification information used to identify the fluorescent reagent 10A and the production lot of the fluorescent reagent 10A. This identification information will be referred herein to as “reagent identification information 11A”. The reagent identification information 11A is, for example, barcode information such as one-dimensional barcode information or two-dimensional barcode information, but is not limited to such type of information. Even if the fluorescent reagent 10A is the same type of product, its properties differ for each production lot depending on the production method, the state of the cells from which the antibody is obtained, or the like. For example, in the fluorescent reagent 10A, spectral information, quantum yield, fluorescent labeling rate, or the like differ for each production lot. The fluorescence labeling rate is also called “F/P value: Fluorescein/Protein” and refers to the number of fluorescent molecules that label an antibody. Thus, in the information processing system according to the present embodiment, the fluorescent reagent 10A is managed for each production lot by being assigned with the reagent identification information 11A. In other words, reagent information for each fluorescent reagent 10A is managed for each production lot. This allows the information processing apparatus 100 to separate a fluorescent signal and an autofluorescent signal while taking into consideration slight differences in properties that appear for each production lot. Moreover, managing the fluorescent reagent 10A in units of production lots is just an example, and the fluorescent reagents 10A may be managed on a finer unit than production lots.

### (Specimen 20A)

The specimen 20A is prepared from a specimen or tissue sample collected from a human body for the purpose of pathological diagnosis or clinical examination. Regarding the specimen 20A, for example, the type of tissue used such as an organ or cell, the type of disease to be targeted, attributes of the subject such as age, gender, blood type, or race, or lifestyle habits of the subjects such as diet, exercise, or smoking habits, are not limited to the particular examples. Furthermore, the specimen 20A is managed with identification information that allows each specimen 20A to be identified. This identification information will be referred herein to as “specimen identification information 21A”. The specimen identification information 21A is, similar to the reagent identification information 11A, for example, barcode information such as one-dimensional barcode information or two-dimensional barcode information, but is not limited thereto. The properties of the specimen 20A vary depending on the type of tissue used, the type of disease targeted, the attributes of the subject, or the lifestyle habits of the subject. For example, in the specimen 20A, measurement channels or spectral information may vary depending on the type of tissue used or the like. Thus, in the information processing system according to the present embodiment, the specimen 20A is individually managed by attaching the specimen identification information 21A. This allows the information processing apparatus 100 to separate the fluorescent signal and the autofluorescent signal, taking into consideration even the slight differences in properties that appear for each specimen 20A.

### (Fluorescent-Stained Specimen 30A)

The fluorescent-stained specimen 30A is created by staining the specimen 20A with the fluorescent reagent 10A. In the present embodiment, the fluorescent-stained specimen 30A assumes that the specimen 20A is stained with at least one fluorescent reagent 10A, but the number of fluorescent reagents 10A used for staining is not limited to a particular one. Furthermore, the staining method is determined by various combinations of the specimen 20A and the fluorescent reagent 10A, and is not limited to a particular one. The fluorescent-stained specimen 30A is input to and image-captured by the information processing apparatus 100.

### (Information Processing Apparatus 100)

The information processing apparatus 100, as illustrated in FIG. 1, includes an acquisition unit 110, a storage unit 120, a processing unit 130, a display unit 140, a control unit 150, and an operation unit 160.

### (Acquisition Unit 110)

The acquisition unit 110 is configured to acquire information used in various types of processing in the information processing apparatus 100. As illustrated in FIG. 1, the acquisition unit 110 includes an information acquisition unit 111 and an image acquisition unit 112.

### (Information Acquisition Unit 111)

The information acquisition unit 111 is configured to acquire reagent information and specimen information. More specifically, the information acquisition unit 111 acquires the reagent identification information 11A attached to the fluorescent reagent 10A being used to generate the fluorescent-stained specimen 30A, and it also acquires the specimen identification information 21A attached to the specimen 20A. For example, the information acquisition unit 111 acquires the reagent identification information 11A and the specimen identification information 21A using a barcode reader or the like. Then, the information acquisition unit 111 acquires reagent information from the database 200 on the basis of the reagent identification information 11A and acquires specimen information on the basis of the specimen identification information 21A. The information acquisition unit 111 stores the acquired information in an information storage unit 121, which will be described later.

### (Image Acquisition Unit 112)

The image acquisition unit 112 is configured to acquire image information of the fluorescent-stained specimen 30A and the specimen 20A stained with at least one fluorescent reagent 10A. More specifically, the image acquisition unit 112 includes an optional image sensor such as a CCD or CMOS to acquire image information by image-capturing the fluorescent-stained specimen 30A using the image sensor. In this regard, it should be noted that “image information” is a concept that includes not only the image itself of the fluorescent-stained specimen 30A but also measurements that are not visualized as an image, such as numerical values. For example, the image information may include information regarding the wavelength spectrum of fluorescence emitted from the fluorescent-stained specimen 30A. The wavelength spectrum of fluorescence is referred herein to as a fluorescence spectrum. The image acquisition unit 112 stores the image information in an image information storage unit 122, which will be described later.

### (Storage Unit 120)

The storage unit 120 is configured to store information used in various types of processing in the information processing apparatus 100 or store information output from various types of processing. As illustrated in FIG. 1, the storage unit 120 includes an information storage unit 121, an image information storage unit 122, and an analysis result storage unit 123.

### (Information Storage Unit 121)

The information storage unit 121 is configured to store the reagent information and specimen information acquired by the information acquisition unit 111. Moreover, after completing analysis processing by an analysis unit 131 and image information generation processing by an image generation unit 132, that is, completing image information reconstruction processing, which will be described later, the information storage unit 121 may increase empty or available space by deleting the reagent information and specimen information used in the processing.

### (Image Information Storage Unit 122)

The image information storage unit 122 is configured to store the image information of the fluorescent-stained specimen 30A acquired by the image acquisition unit 112. Moreover, similarly to the information storage unit 121, after completing the analysis processing by the analysis unit 131 and the image information generation processing by the image generation unit 132, that is, completing the image information reconstruction processing, the image information storage unit 122 may increase available space by deleting image information used for processing.

### (Analysis Result Storage Unit 123)

The analysis result storage unit 123 is configured to store a result obtained from the analysis processing performed by the analysis unit 131, which will be described later. For example, the analysis result storage unit 123 stores a fluorescence signal of the fluorescent reagent 10A or an autofluorescence signal of the specimen 20A, which are separated by the analysis unit 131. Additionally, the analysis result storage unit 123 separately provides the results obtained from the analysis processing to the database 200 to improve the analysis accuracy through machine learning or the like. Moreover, after providing the results of the analysis processing to the database 200, the analysis result storage unit 123 may increase its available space by appropriately deleting the result of the analysis processing that it has stored.

### (Processing Unit 130)

The processing unit 130 has a functional configuration that performs various types of processing using the image information, reagent information, and specimen information. As illustrated in FIG. 1, the processing unit 130 includes an analysis unit 131, an image generation unit 132, a guide image generation unit 133, and a correction unit 134.

### (Analysis Unit 131)

The analysis unit 131 is configured to perform various types of analysis processing using the image information, specimen information, and reagent information. For example, the analysis unit 131 performs processing of separating the autofluorescence signal of the specimen 20A from the image information on the basis of the specimen information and reagent information. This autofluorescence signal, for instance, includes an autofluorescence spectrum as an example of an autofluorescent component, and the fluorescence signal of the fluorescent reagent 10A, for instance, includes a stained fluorescence spectrum as an example of the stained fluorescent component.

More specifically, the analysis unit 131 recognizes one or more components that constitute the autofluorescence signal on the basis of the measurement channel included in the specimen information. For example, the analysis unit 131 recognizes one or more autofluorescence components that constitute the autofluorescence signal. Then, by using the spectral information of these autofluorescence components included in the specimen information, the analysis unit 131 predicts the autofluorescence signal included in the image information. Then, the analysis unit 131 separates the autofluorescence signal and the fluorescence signal from the image information on the basis of the spectral information of the fluorescent component of the fluorescent reagent 10A included in the reagent information and the predicted autofluorescence signal.

In this regard, in the case where the specimen 20A is stained with two or more fluorescent reagents 10A, the analysis unit 131 separates the fluorescence signal of each of these two or more fluorescent reagents 10A from the image information or from the fluorescence signal separated from the autofluorescence signal, based on the specimen information and reagent information. For example, the analysis unit 131 separates the fluorescence signal of each of the fluorescent reagents 10A from the entire fluorescence signals separated from the autofluorescence signal using the spectral information of the fluorescent component of each of the fluorescent reagents 10A included in the reagent information.

Further, in the case where the autofluorescence signal is composed of two or more autofluorescence components, the analysis unit 131 separates the autofluorescence signal of each of these autofluorescent components from the image information or from the autofluorescence signal separated from the fluorescence signals, based on the specimen information and reagent information. For example, the analysis unit 131 uses the spectral information of each autofluorescent component included in the specimen information to separate the autofluorescent signal of each autofluorescent component from the entire autofluorescent signal after being separated from the fluorescent signal.

The analysis unit 131, having separated the fluorescent signal and the autofluorescent signal, performs various types of processing using these signals. For example, the analysis unit 131 may use the separated autofluorescence signal to perform subtraction processing on the image information of another specimen 20A, extracting the fluorescence signal from the image information of the other specimen 20A. The subtraction processing is also called “background subtraction processing”. In the case where there are multiple specimens 20A that are identical or similar in terms of the tissue used for the specimen 20A, the type of disease being targeted, the attribute of the subject, the subject's lifestyle habits, or the like, the autofluorescence signals of these specimens 20A are likely to be similar. The term “similar specimen 20A” used herein includes, for example, a tissue section before staining that is to be stained, a section adjacent to the stained section, a different section within the same block as the stained section, or a section from a different block within the same tissue, including a section taken from a different patient or the like. The tissue section is simply referred to herein as “section”. The “same block” refers to one sampled from the same location as the stained section. The “different block” refers to one sampled from a location different from the stained section. Thus, in the case where the analysis unit 131 is capable of extracting the autofluorescence signal from a certain specimen 20A, the analysis unit 131 may also extract the fluorescence signal from the image information of another specimen 20A by removing the concerned autofluorescence signal from the other specimen 20A. Furthermore, in calculating the S/N ratio using the image information of the other specimen 20A, it is possible for the analysis unit 131 to improve the S/N ratio by using the background after removing the autofluorescence signal.

Further, in addition to the background subtraction processing, the analysis unit 131 is capable of performing various types of processing using the separated fluorescent signal or the separated autofluorescent signal. For example, using these signals, the analysis unit 131 is capable of analyzing the fixation state of the specimen 20A, or performing segmentation or regional fragmentation to recognize a region containing an object in the image information. Examples of such an object include a cell, an intracellular structure, or a tissue. Examples of the intracellular structure include cytoplasm, cell membrane, nucleus, or the like. Examples of the tissue include a tumor site, non-tumor site, connective tissue, blood vessel, vascular wall, lymph vessel, fibrotic structure, necrosis, or the like.

### (Image Generation Unit 132)

The image generation unit 132 is configured to generate image information on the basis of the fluorescence signal or autofluorescence signal separated by the analysis unit 131, in other words, it reconstructs the image information. For example, the image generation unit 132 is capable of generating image information that includes only the fluorescent signal or only the autofluorescent signal. In this event, if the fluorescent signal is composed of a plurality of fluorescent components, or if the autofluorescent signal is composed of a plurality of autofluorescent components, the image generation unit 132 is capable of generating image information for each component. Furthermore, in the case where the analysis unit 131 performs various types of processing using the separated fluorescent signal or autofluorescent signal, the image generation unit 132 may generate image information indicating the result of those processing operations. Examples of the various types of processing include analysis of the fixation state of the specimen 20A, segmentation, calculation of the S/N value, or the like. This configuration makes it possible to visualize the distribution information of the fluorescent reagent 10A labeled on the target molecule or the like, that is, the two-dimensional spread, intensity, wavelength, and positional relationship of the fluorescence, and particularly, to improve the visibility of information regarding target substances for users such as doctors and researchers in the complex tissue image analysis region.

Furthermore, the image generation unit 132 may be controlled to distinguish the fluorescence signal from the autofluorescence signal on the basis of the fluorescence signal or autofluorescence signal separated by the analysis unit 131, and it may generate image information accordingly. Specifically, it may generate the image information by the control of enhancing the brightness of the fluorescence spectrum of the fluorescent reagent 10A labeled on target molecules, extracting and changing the color of only the fluorescence spectrum of the labeled fluorescent reagent 10A, extracting the fluorescence spectrum of two or more fluorescent reagents 10A from the specimen 20A labeled with two or more fluorescent reagents 10A and changing each to a different color, extracting only the autofluorescence spectrum of the specimen 20A and performing division or subtraction, improving the dynamic range, or the like. This enables the user to clearly distinguish the color information derived from the fluorescent reagent bound to the desired target substance, thus improving the user's visibility.

### (Guide Image Generation Unit 133)

The guide image generation unit 133 generates a guide image for correction by merging a plurality of color-separated images (an example of multispectral images) and then performing a division on the result by the number of merged images. The color-separated image is an image generated by color separation processing. Furthermore, summing up images and then performing a division involves summing up the signal intensities of the images and then performing a division on the result by the number of summed images. Additionally, the guide image generation unit 133 is capable of executing image processing after the merging and dividing processing upon generation of the guide image, or performing zero-filling processing on the color-separated images before the merging and dividing processing. In the image processing, for example, a noise removal filter, an edge enhancement filter, or the like is used. Details of such guide image generation processing and the like will be described later.

### (Correction Unit 134)

The correction unit 134 performs noise reduction (NR) correction on the color-separated image (an example of a processing-target image) using the generated guide image. Additionally, the correction unit 134 is capable of performing outlier processing on the color-separated image before the correction processing. The outlier processing involves, for example, removing signal intensity values that significantly deviate from other signal intensity values, such as those of red blood cells. Details on such correction processing or the like will be described later.

### (Display Unit 140)

The display unit 140 is configured to present to the user the corrected image information (information regarding the corrected image) generated by the correction unit 134 by displaying it on a display. Moreover, the type of display used as the display unit 140 is not limited to a particular one. Additionally, although not described in detail in the present embodiment, the image information subjected to correction generated by the correction unit 134 may be presented to the user by being projected by a projector or printed by a printer. In other words, the method of outputting the corrected image information is not limited to a particular one.

### (Control Unit 150)

The control unit 150 is a functional configuration that centrally controls the overall processing performed by the information processing apparatus 100. For example, the control unit 150 controls the start and end of various types of processing as described above on the basis of operation input by the user made through the operation unit 160. Examples of the various types of processing may include imaging processing of the fluorescent-stained specimen 30A, analysis processing, image information generation processing, guide image information generation processing, image information correction processing, and image information display processing. Examples of the image information generation processing may include an image information reconstruction processing. Moreover, the details of the control by the control unit 150 are not limited to a particular one. For example, the control unit 150 may control processing commonly performed in general-purpose computers, PCs, tablet PCs, or the like, such as processing related to an operating system (OS).

### (Operation Unit 160)

The operation unit 160 is configured to receive operation input from the user. More specifically, the operation unit 160 includes various input means such as a keyboard, mouse, button, touch panel, or microphone, and the user is able to perform various operations on the information processing apparatus 100 by operating these input means. Information regarding the operation input performed through the operation unit 160 is provided to the control unit 150.

### (Database 200)

The database 200 is a device that manages the specimen information, the reagent information, and the result of analysis processing. More specifically, the database 200 associates and manages the specimen identification information 21A and the specimen information and associates and manages the reagent identification information 11A and the reagent information. This arrangement makes it possible for the information acquisition unit 111 to acquire the specimen information on the basis of the specimen identification information 21A of the specimen 20A to be measured from the database 200 and acquire the reagent information on the basis of the reagent identification information 11A of the fluorescent reagent 10A from the database 200.

The specimen information managed by the database 200, as described above, is information including the intrinsic measurement channels and spectral information of autofluorescent component present in the specimen 20A. However, in addition to these, the specimen information may also include target information for each specimen 20A, specifically, the type of tissue used, such as organs, cells, blood, bodily fluids, ascites, pleural effusion, or the like, the type of diseases targeted, attributes of the subject, such as age, gender, blood type, or race, or information regarding the subject's lifestyle habits, such as diet, exercise habits, or smoking habits. The information including the intrinsic measurement channels and spectral information of the autofluorescent component present in the specimen 20A, as well as the target information, may be associated with each specimen 20A. This makes it possible to easily trace information including the intrinsic measurement channels and spectral information of the autofluorescent component present in the specimen 20A from the target information, and this enables the execution of similar separation processing operations previously performed by the analysis unit 131, for example, on the basis of the similarity of target information across multiple specimens 20A, thus reducing measurement time. Moreover, the “tissue used” is not particularly limited to tissue collected from a subject but may include in-vivo tissues and cell lines of humans, animals, or the like, as well as solutions, solvents, solutes, and materials contained in the object of measurement.

In addition, the reagent information managed by the database 200, as described above, includes information containing the spectral information of the fluorescent reagent 10A. However, in addition to this, the reagent information may include information regarding the fluorescent reagent 10A, such as production lot, fluorescent components, antibodies, clones, fluorescence labeling rate, quantum yield, photobleaching coefficient, and absorption cross-section or molar absorptivity coefficient. The photobleaching coefficient is information indicating the ease with which the fluorescence intensity of the fluorescent reagent 10A diminishes. Furthermore, the specimen information and reagent information managed by the database 200 may be managed in different configurations, and in particular, information regarding reagents may be a reagent database that presents the users with the optimal combination of reagents.

It is herein assumed that the specimen information and the reagent information are either provided by a manufacturer or the like, or independently measured within the information processing system according to the present disclosure. For example, the manufacturer of the fluorescent reagent 10A often does not measure and provide the spectral information, fluorescent labeling rate, or the like for each production lot. Thus, independently measuring and managing such information within the information processing system according to the present disclosure makes it possible to improve the separation accuracy between fluorescent signal and autofluorescent signal. Additionally, for the sake of simplifying management, the database 200 may use a catalog value publicly available from manufacturers or the like or a value documented in various literature sources as specimen information and reagent information, especially as reagent information. However, actual specimen information and reagent information are often different from the catalog value or literature value, so it is generally preferable for specimen information and reagent information to be independently measured and managed within the information processing system according to the present disclosure, as described above.

Further, using machine learning technology or the like that employs the specimen information, reagent information, and analysis processing results managed in the database 200 makes it possible to improve, for example, the accuracy of analysis processing, such as the separation of fluorescent signals from the autofluorescence signal. Although the component that performs learning using machine learning technology or the like is not limited to a particular one, and in the present embodiment, a case where the analysis unit 131 of the information processing apparatus 100 performs the learning will be described as an example. For example, the analysis unit 131 uses a neural network to create a classifier or estimator that has been machine-learned with learning data linking the separated fluorescent signals and autofluorescent signals to the image information, specimen information, and reagent information used for separation. Then, in the case where new image information, specimen information, and reagent information are acquired, the analysis unit 131 is capable of inputting these types of information into the classifier or estimator to predict and output the fluorescence signal and autofluorescence signal included in the image information.

Further, it may be possible to calculate previously performed similar separation processing operations with higher accuracy than the predicted fluorescent signal and autofluorescent signal, statistically or regressively analyze the details of those processing operations, and output a method of improving the separation processing of the fluorescent signal and autofluorescent signal on the basis of the analysis result. The separation processing is, for example, separation processing in which similar types of image information, specimen information, and reagent information are used. The details of the processing include, for example, information and a parameter used in the processing. Moreover, the machine learning method is not limited to the above examples and may employ known machine learning techniques. Additionally, the separation processing between the fluorescent signal and the autofluorescent signal may also be performed by artificial intelligence. Additionally, various types of processing using the fluorescent signal or autofluorescent signal after separation, such as analysis of the fixation or immobilization state of the specimen 20A or segmentation, or the like, may be improved by machine learning techniques.

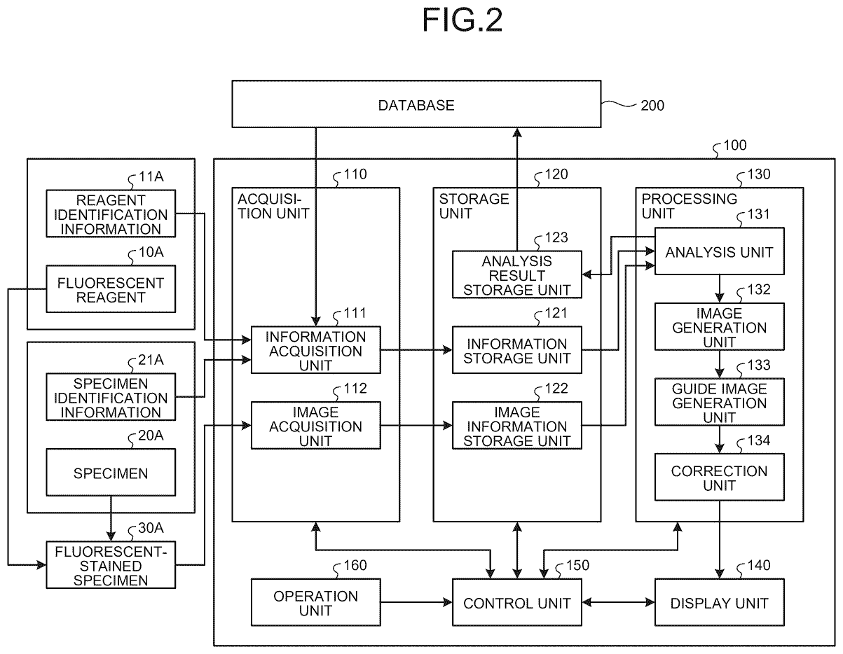

The description above is given on the configuration example of the information processing system according to the present embodiment. Moreover, the configuration described with reference to FIG. 2 is merely an example, and the configuration of the information processing system according to the present embodiment is not limited to the above examples. In one example, the information processing apparatus 100 may not necessarily include all the functional components illustrated in FIG. 2. Additionally, the information processing apparatus 100 may include the database 200 internally. The functional configuration of the information processing apparatus 100 can be flexibly modified according to specifications and operations.

Additionally, the information processing apparatus 100 may perform processing operations other than those described above. For example, by including information such as the quantum yield, fluorescent labeling rate, absorption cross-section, or molar absorptivity coefficient regarding the fluorescent reagent 10A in the reagent information, the information processing apparatus 100 may calculate the number of fluorescent molecules in the image information, the number of antibodies bound to fluorescent molecules, or the like using the image information from which the autofluorescence signal is removed, along with the reagent information.

### 2-2. Basic Processing Example of Information Processing Apparatus

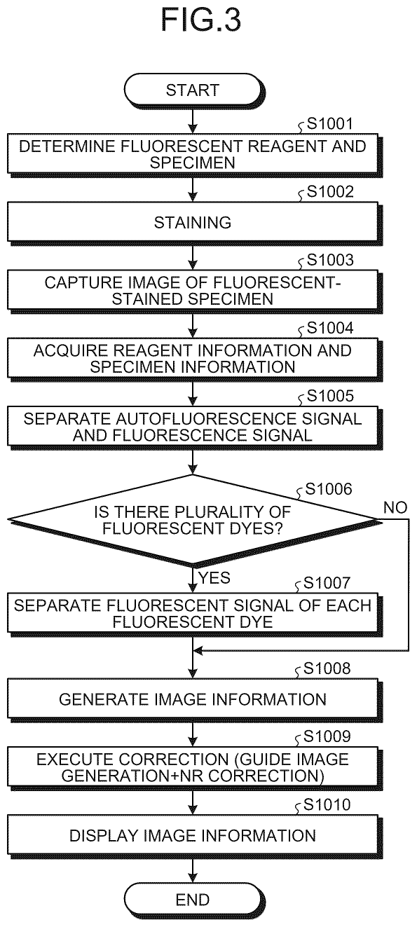

A basic processing example of the information processing apparatus 100 according to the present embodiment is described with reference to FIG. 3. FIG. 3 is a flowchart illustrating an example of the basic processing procedure of the information processing apparatus 100 according to the present embodiment.

As illustrated in FIG. 3, in step S1001, the user determines the fluorescent reagent 10A and the specimen 20A to be used for analysis. In step S1002, the user creates the fluorescent-stained specimen 30A by staining the specimen 20A using the fluorescent reagent 10A.

In step S1003, the image acquisition unit 112 of the information processing apparatus 100 captures an image of the fluorescent-stained specimen 30A, thereby acquiring image information (e.g., a fluorescence-stained specimen image). In step S1004, the information acquisition unit 111 acquires the reagent information and the specimen information from the database 200, based on the reagent identification information 11A attached to the fluorescent reagent 10A used to produce the fluorescent-stained specimen 30A and the specimen identification information 21A attached to the specimen 20A.

In step S1005, the analysis unit 131 separates the autofluorescence signal of the specimen 20A and the fluorescence signal of the fluorescent reagent 10A from the image information on the basis of the specimen information and the reagent information. In this regard, if the fluorescent signal includes signals of a plurality of fluorescent dyes (Yes in step S1006), the analysis unit 131 separates the fluorescent signal of each fluorescent dye in step S1007. Moreover, if the fluorescent signal does not include signals of a plurality of fluorescent dyes (No in step S1006), the separation processing on the fluorescent signal of each fluorescent dye is not performed in step S1007.

In step S1008, the image generation unit 132 generates the image information using the fluorescent signal separated by the analysis unit 131. For example, the image generation unit 132 generates the image information from which the autofluorescent signal is removed, or the image information in which the fluorescent signal is displayed for each fluorescent dye. In step S1009, the guide image generation unit 133 generates the guide image, and the correction unit 134 performs NR correction on the color-separated image, for example, using the guide image. In step S1010, the display unit 140 displays the image information corrected by the correction unit 134, thereby ending the series of processing operations.

Moreover, the respective steps in the flowchart of FIG. 3 do not necessarily need to be processed chronologically in the order described. In other words, the steps in the flowchart may be processed in different orders than the one described, or they may be processed in parallel.

In one example, instead of separating the autofluorescence signal of the specimen 20A and the fluorescence signal of the fluorescent reagent 10A from the image information in step S1005 and then separating the fluorescent signal of each fluorescent dye in step S1007, the analysis unit 131 may directly separate the fluorescence signal of each fluorescent dye from the image information. Additionally, after separating the fluorescence signal of each fluorescent dye from the image information, the analysis unit 131 may separate the autofluorescence signal of the specimen 20A from the image information.

Further, the information processing apparatus 100 may also execute processing not illustrated in FIG. 3. For example, the analysis unit 131 may not only separate signals, but also perform segmentation on the basis of the separated fluorescent signals or autofluorescent signals, or may analyze the fixation state of the specimen 20A.

### 2-3. Example of Fluorescence Separation Processing

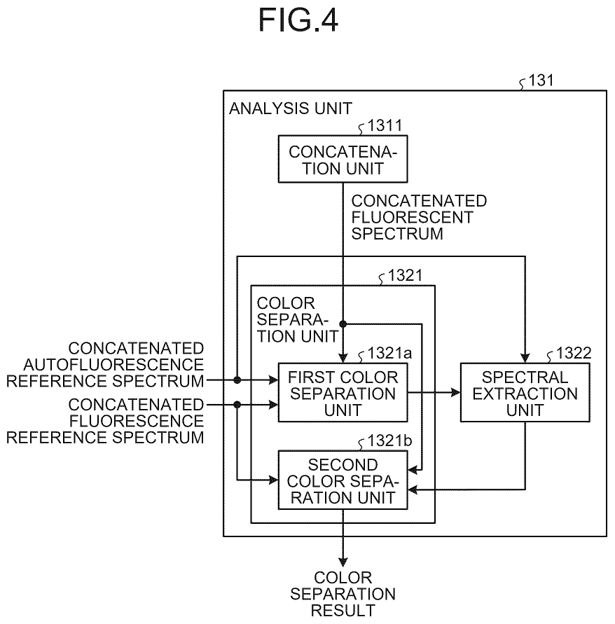

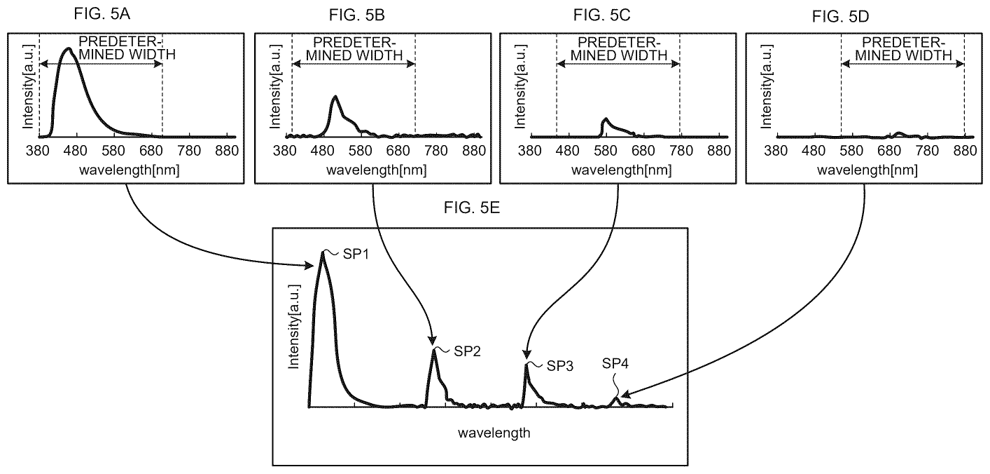

An example of fluorescence separation processing according to the present embodiment is described with reference to FIGS. 4 and 5. FIG. 4 is a diagram illustrating an exemplary schematic configuration of the analysis unit 131 according to the present embodiment. FIG. 5 is a diagram illustrated to describe an example of a method of generating a concatenated fluorescence spectrum according to the present embodiment.

As illustrated in FIG. 4, the analysis unit 131 includes a concatenation unit 1311, a color separation unit 1321, and a spectral extraction unit 1322. The analysis unit 131 is configured to perform various types of processing that includes fluorescence separation processing. For example, the analysis unit 131 is configured to concatenate fluorescence spectra as pre-processing for the fluorescence separation processing, and then separate the concatenated fluorescence spectra for each molecule.

### (Concatenation Unit 1311)

The concatenation unit 1311 is configured to generate a concatenated fluorescence spectrum by concatenating at least a portion of the plurality of fluorescence spectra acquired by the image acquisition unit 112 in the wavelength direction. For example, the concatenation unit 1311 extracts data of a predetermined width in each fluorescence spectrum, ensuring that each fluorescence spectrum includes the maximum fluorescence intensity value obtained from four fluorescence spectra (labeled as A to D in FIG. 5) acquired by the image acquisition unit 112. The width of the wavelength band from which the concatenation unit 1311 extracts data may be determined on the basis of the reagent information, excitation wavelength, fluorescence wavelength, or the like, and may vary for each fluorescent substance. In other words, the width of the wavelength band from which the concatenation unit 1311 extracts data may vary for each of the fluorescence spectra illustrated as labels A to D in FIG. 5. Then, as illustrated in E of FIG. 5, the concatenation unit 1311 generates a single concatenated fluorescence spectrum by concatenating the extracted data with each other in the wavelength direction. Moreover, the concatenated fluorescence spectrum is composed of data extracted from a plurality of fluorescence spectra, so it should be noted that the wavelength is not continuous at the boundary of each concatenated data.

In this event, the concatenation unit 1311 aligns the intensities of excitation light corresponding to the respective multiple fluorescence spectra on the basis of the intensity of the excitation light, in other words, corrects the multiple fluorescence spectra, before proceeding with the aforementioned concatenation. More specifically, the concatenation unit 1311 aligns the intensities of the excitation light corresponding to the respective multiple fluorescence spectra by dividing each fluorescence spectrum by the excitation power density, which is the intensity of the excitation light, before performing the aforementioned concatenation. This allows for the acquisition of the fluorescence spectrum in the case of being irradiated with excitation light of the same intensity. Moreover, in the case where the intensity of the irradiated excitation light varies, the intensity of the spectrum absorbed by the fluorescent-stained specimen 30A also varies according to the intensity. This spectrum will be herein referred to as an “absorption spectrum”. Thus, as described above, aligning the intensities of the excitation light corresponding to the respective multiple fluorescence spectra makes it possible to appropriately evaluate the absorption spectrum.

In this regard, labels A to D in FIG. 5 are specific examples of fluorescence spectra acquired by the image acquisition unit 112. In labels A to D of FIG. 5, the fluorescent-stained specimen 30A includes four types of fluorescent substances, for example, DAPI, CK/AF488, PgR/AF594, and ER/AF647, and the specific examples of the fluorescence spectra obtained in the case of being irradiated with excitation light of respective excitation wavelengths of 392 nm (A in FIG. 5), 470 nm (B in FIG. 5), 549 nm (C in FIG. 5), and 628 nm (D in FIG. 5) are illustrated. Moreover, it should be noted that the fluorescence wavelength is shifted to a longer wavelength than the excitation wavelength (Stokes shift) due to the release of energy for fluorescence emission. Furthermore, the fluorescent substance contained in the fluorescent-stained specimen 30A and the excitation wavelength of the excitation light to be irradiated are not limited to those mentioned above.

Specifically, the concatenation unit 1311 extracts a fluorescence spectrum SP1 from the fluorescence spectrum illustrated in A of FIG. 5, within the wavelength range from the excitation wavelength of 392 nm or more to 591 nm or less, extracts a fluorescence spectrum SP2 from the fluorescence spectrum illustrated in B of FIG. 5, within the wavelength range from the excitation wavelength of 470 nm or more to 669 nm or less, extracts a fluorescence spectrum SP3 from the fluorescence spectrum illustrated in C of FIG. 5, within the wavelength range from the excitation wavelength of 549 nm or more to 748 nm or less, and extracts a fluorescence spectrum SP4 from the fluorescence spectrum illustrated in D of FIG. 5, within the wavelength range from the excitation wavelength of 628 nm or more to 827 nm or less. Then, the concatenation unit 1311 corrects the wavelength resolution of the extracted fluorescence spectrum SP1 to 16 nm (no intensity correction), corrects the intensity of the fluorescence spectrum SP2 to 1.2 times and its wavelength resolution to 8 nm, corrects the intensity of the fluorescence spectrum SP3 by 1.5 times (no wavelength resolution correction), and corrects the intensity of the fluorescence spectrum SP4 by 4.0 times and its wavelength resolution to 4 nm. Then, the concatenation unit 1311 sequentially concatenates the corrected fluorescence spectra SP1 to SP4 to generate a concatenated fluorescence spectrum as illustrated in E of FIG. 5.

Moreover, although FIG. 5 illustrates the case where the concatenation unit 1311 extracts and connects fluorescence spectra SP1 to SP4 of a predetermined bandwidth (200 nm width in FIG. 5) from the excitation wavelength at which each fluorescence spectrum is acquired, the bandwidths of the fluorescence spectra extracted by the concatenation unit 1311 do not need to be consistent across all the fluorescence spectra, and they may vary. In other words, the region extracted from each fluorescence spectrum by the concatenation unit 1311 may be a region including the peak wavelength of each fluorescence spectrum, and the wavelength band and bandwidth thereof may be modified as appropriate. In this event, consideration may be given to deviations in spectral wavelengths due to Stokes shift. In this way, by narrowing down the wavelength band to be extracted, it is possible to reduce the amount of data, thereby enabling faster execution of the fluorescence separation processing.

Further, as described herein, the intensity of the excitation light may be the excitation power or excitation power density, as mentioned above. The excitation power or excitation power density may be the power or power density obtained by actually measuring the excitation light emitted from the light source, or it may be the power or power density determined from the driving voltage applied to the light source. Moreover, the intensity of excitation light herein may be a value obtained by correcting the above-mentioned excitation power density with the absorption rate of the excitation light by the section being observed, or the amplification rate of the detection signal in the detection system for detecting the fluorescence emitted from the section, for example, in the image acquisition unit 112 or the like. In other words, the intensity of the excitation light herein may be the power density of the excitation light that actually contributes to the excitation of the fluorescent substance, or the value obtained by correcting the power density by the amplification rate of the detection system or the like. By considering absorption rate, amplification factor, or the like, it is possible to appropriately correct the intensity of excitation light that varies depending on fluctuations in machine conditions, environment, or the like, thereby enabling the generation of concatenated fluorescence spectra that allow for higher precision in color separation.

Moreover, the correction value based on the intensity of excitation light for each fluorescence spectrum is not limited to a value to align the intensity of excitation light corresponding to each of a plurality of fluorescence spectra, and may be modified in various ways. The above-mentioned correction value is also referred to as an intensity correction value. For example, the signal intensity of a fluorescence spectrum that has an intensity peak on the longer wavelength side tends to be lower than the signal intensity of a fluorescence spectrum that has an intensity peak on the shorter wavelength side. Thus, in the case where a concatenated fluorescence spectrum includes both a fluorescence spectrum with an intensity peak on the longer wavelength side and a fluorescence spectrum with an intensity peak on the shorter wavelength side, there is a tendency for the fluorescence spectrum with an intensity peak on the longer wavelength side to be almost disregarded, and only the fluorescence spectrum with an intensity peak on the shorter wavelength side is extracted. In such cases, for example, by setting a larger intensity correction value for a fluorescence spectrum having an intensity peak on the long wavelength side, it is also possible to improve the separation precision of the fluorescence spectrum with an intensity peak on the shorter wavelength side.

### (Color Separation Unit 1321)

The color separation unit 1321 includes, for example, a first color separation unit 1321a and a second color separation unit 1321b, and separates the concatenated fluorescence spectrum of the stained section that is input from the concatenation unit 1311 into a color for each molecule. The stained section is also referred to as a stained sample.

More specifically, the first color separation unit 1321a performs color separation processing, which uses a concatenated fluorescence reference spectrum included in the reagent information and a concatenated autofluorescence reference spectrum included in the specimen information input from the information storage unit 121, on the concatenated fluorescence spectrum of the stained sample input from the concatenation unit 1311, thereby separating the concatenated fluorescence spectrum into spectra for respective molecules. Moreover, for color separation processing, for example, techniques such as least squares method (LSM), weighted least squares method (WLSM), non-negative matrix factorization (NMF), non-negative matrix factorization employing Gram matrix ^{t}AA, or the like, may be used.

The second color separation unit 1321b performs color separation processing, which uses the concatenated autofluorescence reference spectrum after adjustment that is input from the spectral extraction unit 1322, on the concatenated fluorescence spectrum of the stained sample input from the concatenation unit 1311, thereby separating the concatenated fluorescence spectra into a spectrum for each molecule. Moreover, for color separation processing, similar to the first color separation unit 1321a, for example, techniques, such as the least squares method (LSM), weighted least squares method (WLSM), non-negative matrix factorization (NMF), or non-negative matrix factorization employing Gram matrix AA, or the like, may be used.

In this regard, the least squares method, for example, calculates the mixing ratio by fitting the concatenated fluorescence spectrum, which is generated by the concatenation unit 1311, to the reference spectrum. Furthermore, in the weighted least squares method, the noise in the concatenated fluorescence spectrum (Signal), which is a measured value, is assumed to follow a Poisson distribution, and a weight is applied to emphasize errors at low signal levels. However, the upper limit at which weighting is not applied in the weighted least squares method, is set as the Offset value. The Offset value is determined by the characteristics of the sensor used for measurement, and if an image sensor is used as the sensor, separate optimization is required.

### (Spectral Extraction Unit 1322)

The spectral extraction unit 1322 is configured to improve the concatenated autofluorescence reference spectrum so that more accurate color separation results can be obtained, and the spectral extraction unit 1322 adjusts the concatenated autofluorescence included in the specimen information input from the information storage unit 121 to one that allows a more accurate color separation result to be obtained, based on the color separation result by the color separation unit 1321.

The spectral extraction unit 1322 executes spectral extraction processing using the color separation result input from the first color separation unit 1321a on the concatenated autofluorescence reference spectrum input from the information storage unit 121, and adjusts the concatenated autofluorescence reference spectrum on the basis of the result, improving the concatenated autofluorescence reference spectrum to achieve more accurate color separation result. Moreover, for example, in the spectral extraction processing, techniques such as non-negative matrix factorization (NMF), singular value decomposition (SVD), or the like may be used.

Moreover, although FIG. 4 illustrates the case where the adjustment of the concatenated autofluorescence reference spectrum is performed once, this is not limited to the example presented, and additionally, the color separation result obtained by the second color separation unit 1321b may be input to the spectral extraction unit 1322, and the spectral extraction unit 1322 may repeat the processing of re-adjusting the concatenated autofluorescence reference spectrum one or more times to achieve the final color separation result.

As described above, the first color separation unit 1321a and the second color separation unit 1321b perform fluorescence separation processing using reference spectra concatenated in the wavelength direction (concatenated autofluorescence reference spectrum and concatenated fluorescence reference spectrum), allowing the output of a unique spectrum as the separation result. The separation results are not separated for each excitation wavelength. Thus, the practitioner can obtain the correct spectrum more easily. Additionally, the reference spectrum concerning autofluorescence used for separation (concatenated autofluorescence reference spectrum) is automatically acquired, and by performing fluorescence separation processing, the practitioner no longer needs to extract the spectrum corresponding to autofluorescence from the appropriate space of the unstained tissue section.

### 2-4. Example of NR Correction Processing Using Guide Image

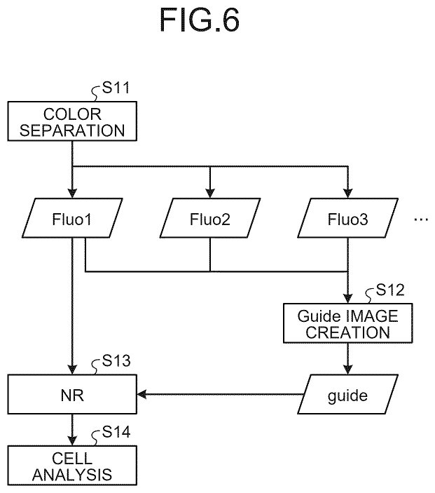

An example of NR correction processing using a guide image according to the present embodiment is described with reference to FIGS. 6 to 22. As processing examples, the first to tenth processing examples are sequentially described.

### 2-4-1. First Processing Example

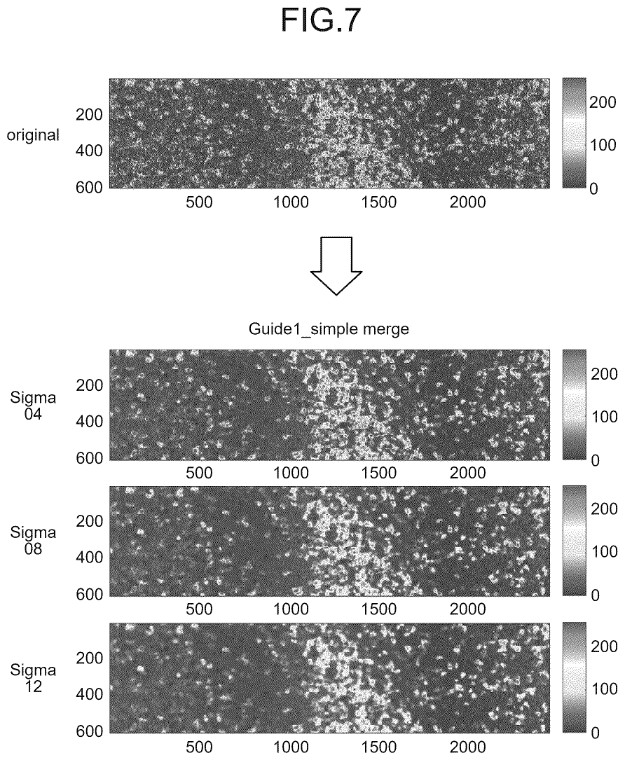

FIG. 6 is a flowchart illustrating the procedure of the first processing example of NR correction using a guide image according to the present embodiment. FIG. 7 is a diagram illustrating a color map for each sigma (Sigma) according to the first processing example according to the present embodiment. Sigma represents the NR intensity.

As illustrated in FIG. 6, in the first processing example, the color separation described above (generation of a color-separated image) is performed in step S11. In step S12, the guide image generation unit 133 merges all images after color separation (color-separated images: Fluo 1, 2, 3, . . . ) and generates the guide image by dividing the result by the number of images merged. In step S13, the correction unit 134 performs NR correction by spatially correlating the brightness of a region in the processing-target image (NR correction target image) with the generated guide image, preserving the brightness of a correlated region while smoothing out other regions. In step S14, cell analysis (e.g., calculation of the positive cell rate) is performed on the NR-corrected image.

In cell analysis, for example, the display unit 140 displays the NR-corrected image. This allows the user to visually recognize the NR-corrected image. Furthermore, the processing-target image for NR correction processing may be either a single image or multiple images. Such a processing-target image is, for example, selected and set by the user. In this event, the user, for example, performs an input operation on the operation unit 160 to select or change the processing-target image.

As illustrated in FIG. 7, the range of smoothing can be adjusted with sigma (Sigma), with a larger sigma resulting in a stronger NR effect. The sigma is information regarding the standard deviation. This sigma may be selected by the user, or may be calculated from the processing-target image, which is the original image. For example, the sigma may initially be automatically calculated and set from the processing-target image, and then changed and set by the user as necessary. In this event, the user selects or changes the sigma by, for example, performing an input operation on the operation unit 160.

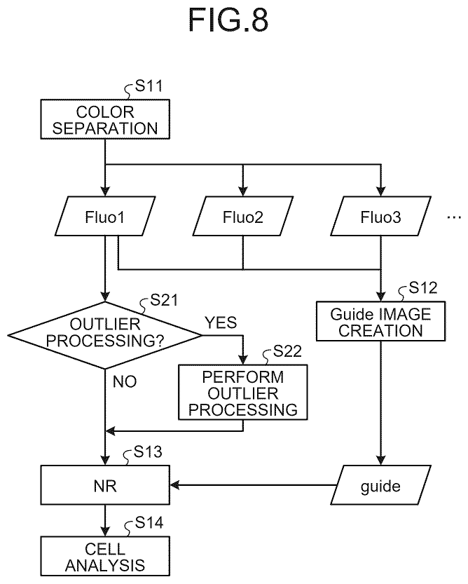

FIG. 8 is a flowchart illustrating the procedure of a modification of the first processing example according to the present embodiment. As illustrated in FIG. 8, in the modification, in addition to the processing of the first processing example described above, in step S21, the correction unit 134 determines whether or not outlier processing is to be performed. If the correction unit 134 determines that outlier processing is necessary (Yes in step S21), the outlier processing is performed and the processing proceeds to step S13. The outlier processing is, for example, zero-filling processing that zeroes out an outlier in the processing-target image in advance. In this way, by zeroing out the outlier in the processing-target image beforehand, more reliable NR correction results can be obtained, preventing the generation of unnecessary artifacts due to NR correction.

### 2-4-2. Second Processing Example

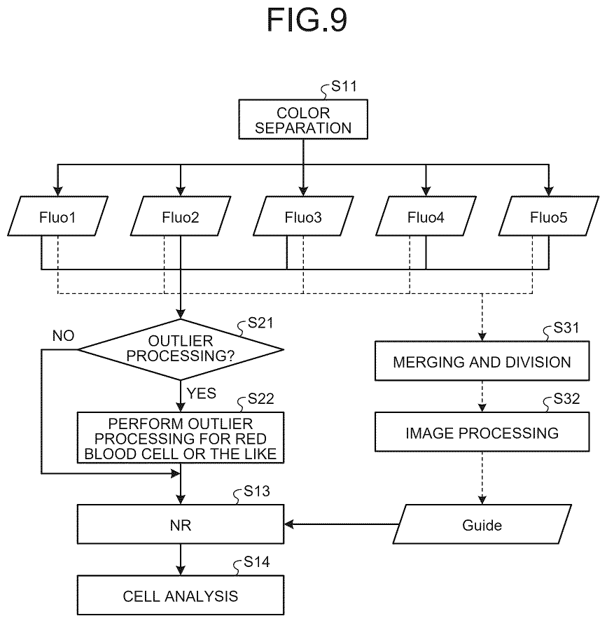

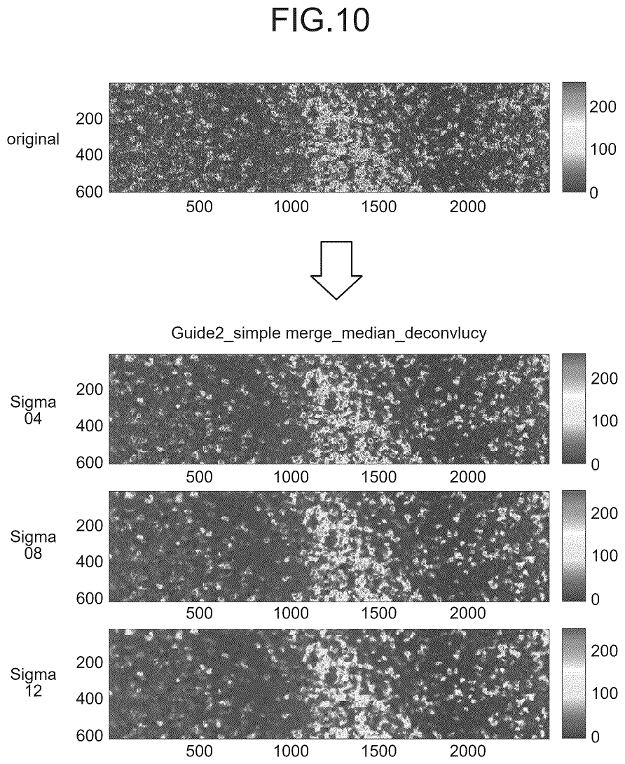

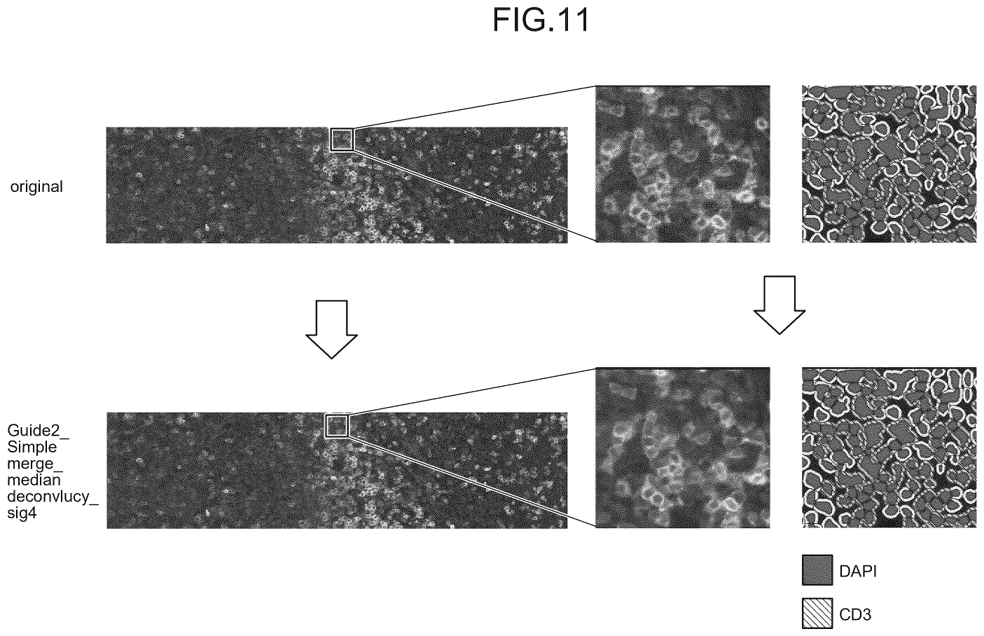

FIG. 9 is a flowchart illustrating the procedure of a second processing example of NR correction using a guide image according to the present embodiment. FIG. 10 is a diagram illustrating a color map for each sigma (Sigma) according to the second processing example according to the present embodiment. Sigma represents the NR intensity. FIG. 11 is a diagram illustrating the benefits of the second processing example in actual cell analysis according to the present embodiment.

As illustrated in FIG. 9, in the second processing example, as the guide image generation (step S12 in FIG. 8) according to the modification of the first processing example described above, the guide image generation unit 133 merges a plurality of images after color separation (color-separated images: Fluo 1, 2, 3, 4, 5) in step S31, performs a division by the number of merged images, and furthermore, executes image processing on the merged and divided image in step S32 to generate the guide image.

As for image processing, for example, it is possible to use techniques such as noise removal processing or edge enhancement processing. In the noise removal processing, for example, a filter such as a median filter, a mean filter, or a Gaussian filter can be used as the noise removal filter. Additionally, in the edge enhancement processing, a filter such as Deconvwnr, Deconvreg, Deconvlucy, Deconvblind, first-order derivative filter, or second-order derivative filter can be used as the edge enhancement filter.

As illustrated in FIG. 10, in the second processing example as well, similar to the first processing example, the range of smoothing can be adjusted by sigma (Sigma), with larger sigma resulting in stronger NR effects. The sigma is information regarding the standard deviation, and as in the first processing example, it may be selected by the user, or it may be calculated from the original image, which is the processing-target image.

In this second processing example, a plurality of multispectral images (e.g., color-separated images) is merged and divided upon creating the guide image and then image processing such as noise removal processing and edge enhancement processing is applied to the merged and divided image, which allows the guide image to have a higher S/N ratio. Thus, enabling the guide image to have a higher S/N ratio makes it possible to enhance the NR effect.

In this regard, as illustrated in FIG. 11, in the image on the right side of the enlarged view in FIG. 11, the filled region of CD3 (filled area with diagonal lines) differs between the original image and the image NR-corrected using the second processing example (image NR-corrected with Guide2_sigma4). In other words, it can be seen that the region that was counted as positive in the original image is counted as negative in the NR-corrected image in the second processing example (image NR-corrected with Guide2_sigma4), indicating a more reliable result.

Moreover, in the second processing example, although the guide image generation unit 133 performs image processing after summing up a plurality of multispectral images and performing a division on the result, this is not limited to such an example, and for example, it is also possible to perform image processing after summing up the plurality of multispectral images and before performing the division.

### 2-4-3. Third Processing Example

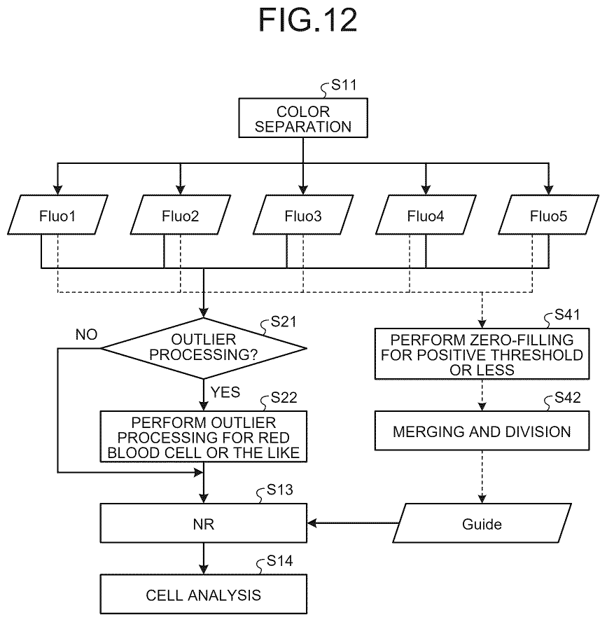

FIG. 12 is a flowchart illustrating the procedure of a third processing example of NR correction using a guide image according to the present embodiment.

As illustrated in FIG. 12, in the third processing example, as the guide image generation (step S12 in FIG. 8) of the modification of the first processing example described above, the guide image generation unit 133 performs zero-filling processing in step S41, where a pixel with a value equal to or less than a predetermined positive threshold in multiple images subjected to color separation (color-separated images: Fluo 1, 2, 3, 4, 5) is set to zero, and furthermore, in step S42, the zero-filled images are merged and divided by the number of merged images to generate the guide image.

In this third processing example, a plurality of multispectral images (e.g., color-separated images) in the case of creating the guide image is preprocessed by zeroing out a pixel equal to or less than a predetermined positive threshold, and then the plurality of multispectral images after zero-filling is merged and divided to generate the guide image with a higher S/N ratio. Thus, enabling the guide image to have a higher S/N ratio makes it possible to enhance the NR effect.

### (Method of Determining Positive Threshold)

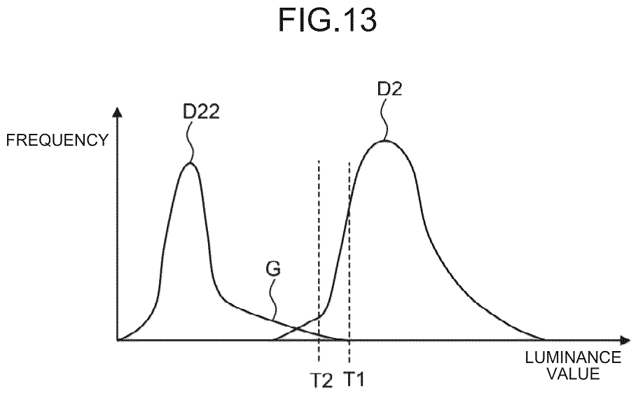

The guide image generation unit 133 is capable of determining the positive threshold for the multispectral image, such as a stained fluorescent component image D2 (see FIG. 13), based on the unstained fluorescent component image D22 (see FIG. 13) derived by the color separation unit 1321 as described above. FIG. 13 is a diagram illustrating an example of a histogram of the stained fluorescent component image D2 and the unstained fluorescent component image D22. In FIG. 13, the X-axis represents luminance values, and the Y-axis represents frequencies. In one example, it is possible to determine the positive threshold on the basis of the luminance value of the unstained fluorescent component image D22. Moreover, the specific method of determining the positive threshold in this example is not limited.

According to this example, the positive threshold is determined on the basis of the unstained fluorescent component image D22 obtained from an unstained specimen fluorescence spectrum D21, which is used as a negative control group. Thus, in the stained fluorescent component image D2, it is possible to accurately distinguish an image section affected by the fluorescence caused by the fluorescent reagent 10A from those unaffected by such fluorescence, and identify it as a positive cell image.

The guide image generation unit 133 may, for example, determine a luminance value (referred to as “T” in FIG. 13) corresponding to an edge (especially the edge on the high luminance value side) of the histogram of the unstained fluorescent component image D22 as the positive threshold. Moreover, the method of determining the edge of the histogram of the unstained fluorescent component image D22 is not limited.

For example, the guide image generation unit 133 may determine the maximum luminance value of the unstained fluorescent component image D22 as the edge of the histogram of the unstained fluorescent component image D22. Alternatively, the guide image generation unit 133 may calculate the slope of the gradient (referred to as “G” in FIG. 13) of the histogram of the unstained fluorescent component image D22 and, based on this slope, determine the edge of the histogram for the unstained specimen fluorescence spectrum D21. In this case, there are no limitations on how to determine the “gradient location for determining the slope” in the histogram of the unstained fluorescent component image D22. For example, the guide image generation unit 133 may determine the gradient location on the basis of the frequency of the luminance value of the unstained fluorescent component image D22. Specifically, it is possible to determine the gradient location in a manner similar to the determination of a “positive threshold T2” described later.

### 2-4-4. Fourth Processing Example

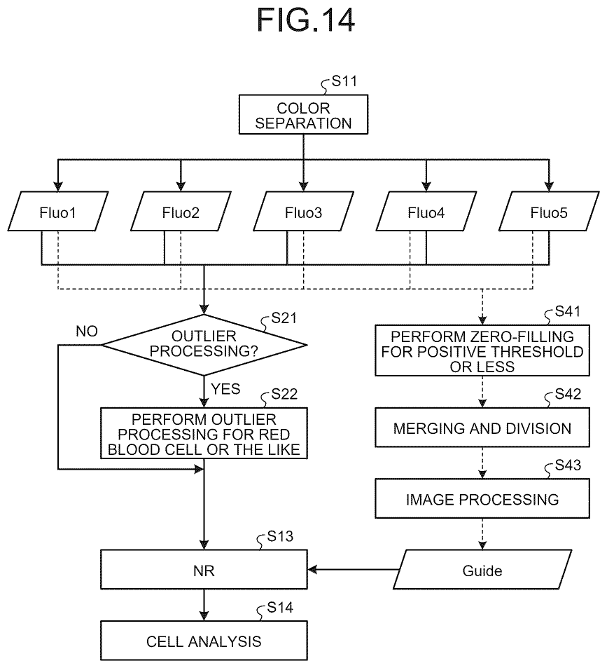

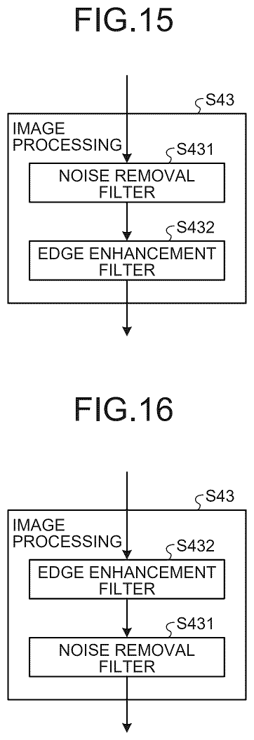

FIG. 14 is a flowchart illustrating the procedure of a fourth processing example of NR correction using a guide image according to the present embodiment. FIGS. 15 and 16 are diagrams, each illustrating an example of image processing according to the present embodiment.

As illustrated in FIG. 14, in the fourth processing example, in addition to the processing of the third processing example described above, in step S43 after steps S41 and S42, the guide image generation unit 133 performs image processing on the merged and divided image to generate the guide image. This image processing is basically similar to the processing in the second processing example, but it may differ in specific procedures.

In this fourth processing example, in the case of creating the guide image, a pixel equal to or less than the positive threshold is zeroed in advance and the result is merged and divided, and then image processing such as noise removal processing and edge enhancement processing is performed on the merged and divided image, thereby enabling the guide image to have a higher S/N ratio. Thus, enabling the guide image to have a higher S/N ratio makes it possible to enhance the NR effect.

As illustrated in FIG. 15, in the image processing of step S43 in FIG. 14, the guide image generation unit 133 may perform image processing using a noise removal filter in step S431, and subsequently may perform image processing using an edge enhancement filter in step S432.

On the other hand, as illustrated in FIG. 16, contrary to the procedure of image processing in FIG. 15, the guide image generation unit 133 may execute image processing using the edge enhancement filter in step S432, and subsequently may execute image processing using the noise removal filter in step S431.

Moreover, the degree of NR effect varies depending on the type of processing-target images, but for example, if the processing-target image is a multispectral image subjected to color separation, then the procedure of image processing in FIG. 15 may achieve better NR effectiveness in comparison between the image processing procedure illustrated in FIG. 15 and the image processing procedure illustrated in FIG. 16.

### 2-4-5. Fifth Processing Example

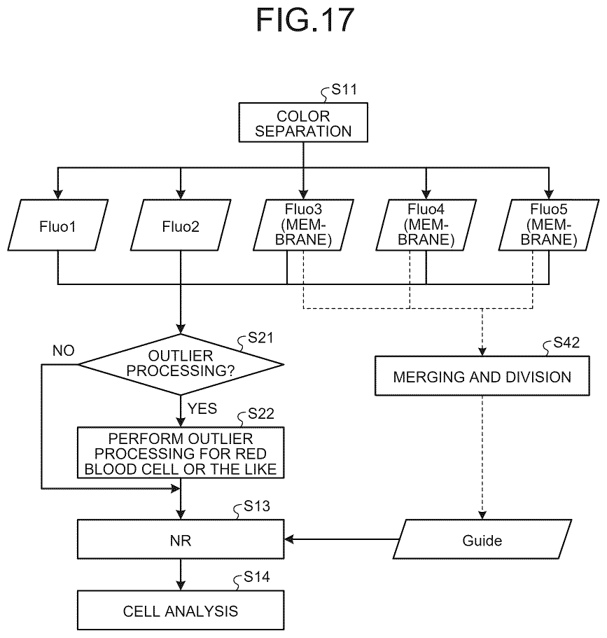

FIG. 17 is a flowchart illustrating the procedure of a fifth processing example of NR correction using a guide image according to the present embodiment.

As illustrated in FIG. 17, in the fifth processing example, the guide image generation unit 133 does not execute step S41 in FIG. 12 of the third processing example described above, and instead, in step S42, it merges a plurality of specific images after color separation, for example, only images corresponding to a specific cell type such as an image of a membrane-stained marker (color-separated images: Fluo 3, 4, 5), and performs a division by the number of merged images to generate the guide image. Moreover, in the example of FIG. 17, only three color-separated images are merged, but the number of images merged is not limited.

In this fifth processing example, in the case of creating the guide image, only images corresponding to a specific cell type, such as membrane-stained markers, are merged and divided, thereby enabling the guide image to have a higher S/N. Thus, enabling the guide image to have a higher S/N ratio makes it possible to enhance the NR effect.

### 2-4-6. Sixth Processing Example

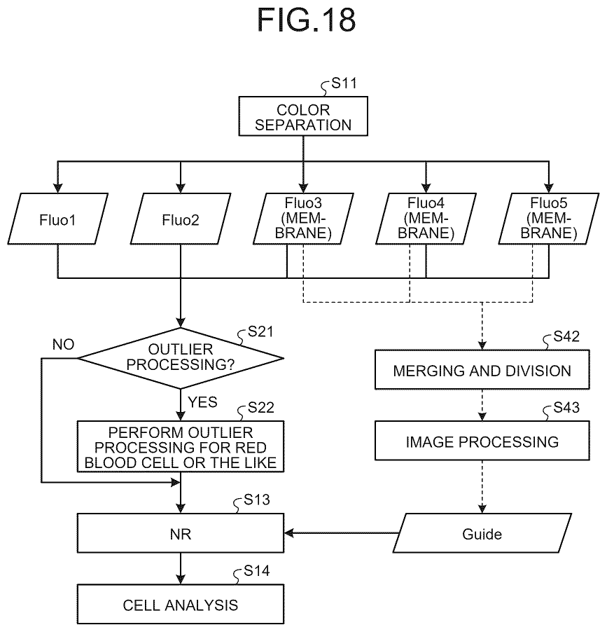

FIG. 18 is a flowchart illustrating the procedure of a sixth processing example of NR correction using a guide image according to the present embodiment.

As illustrated in FIG. 18, in the sixth processing example, in addition to the processing of the fifth processing example described above (see FIG. 17), after step S42, in step S43, the guide image generation unit 133 performs image processing on the image after merging and dividing to generate the guide image. This image processing is basically similar to the processing in the second processing example, but it may differ in specific procedures.

In this sixth processing example, in the case of creating the guide image, only images corresponding to a specific cell type, such as only membrane-stained markers, are merged and divided, and then image processing such as noise removal processing or edge enhancement processing is performed on the merged and divided images, thereby enabling the guide image to have a higher S/N ratio. Thus, enabling the guide image to have a higher S/N ratio makes it possible to enhance the NR effect.

### 2-4-7. Seventh Processing Example

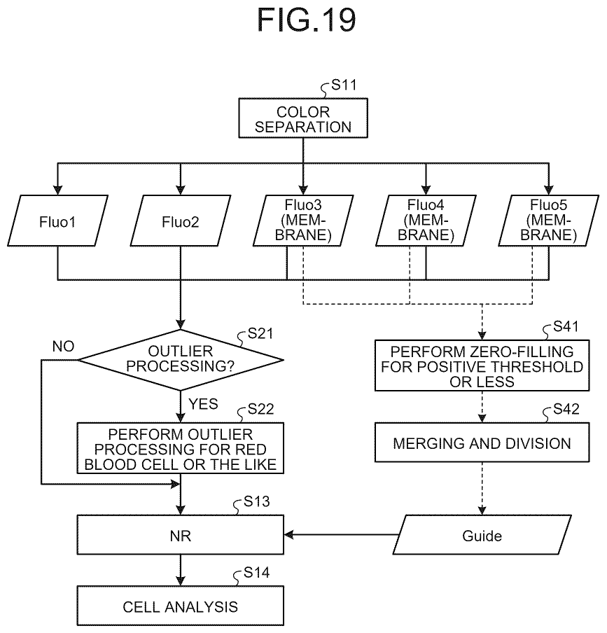

FIG. 19 is a flowchart illustrating the procedure of a seventh processing example of NR correction using a guide image according to the present embodiment.

As illustrated in FIG. 19, in the seventh processing example, in addition to the processing of the fifth processing example described above (see FIG. 17), before step S42, that is, in step S41, the guide image generation unit 133 zeroes out (zero-fills) a pixel equal to or less than a predetermined positive threshold only in a specific image corresponding to a specific cell type, such as membrane-stained markers, from among multiple post-color-separation images (color-separated images: Fluo 3, 4, 5), and furthermore, in step S42, merges the zeroed images and performs a division by the number of merged images to generate the guide image.

In this seventh processing example, in the case of creating the guide image, a pixel equal to or less than a predetermined positive threshold is zeroed out only in the images corresponding to a specific cell type, and then only these zeroed images are merged and divided to enable the guide image to have a higher S/N ratio. Thus, enabling the guide image to have a higher S/N ratio makes it possible to enhance the NR effect.

### 2-4-8. Eighth Processing Example

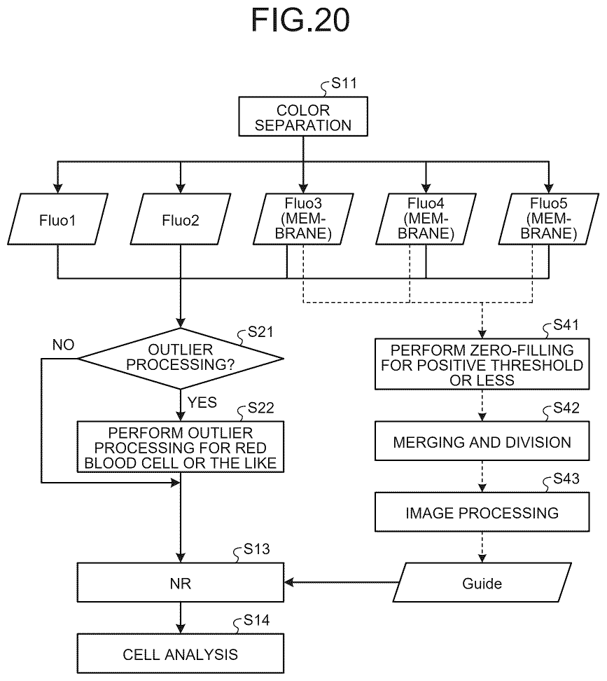

FIG. 20 is a flowchart illustrating the procedure of an eighth processing example of NR correction using a guide image according to the present embodiment.

As illustrated in FIG. 20, in the eighth processing example, in addition to the processing of the seventh processing example described above (see FIG. 19), in step S43 after steps S41 and S42, the guide image generation unit 133 performs image processing on the image subjected to merging and dividing to generate the guide image. This image processing is basically similar to the processing in the second processing example, but it may differ in specific procedures.

According to this eighth processing example, in the case of creating the guide image, by zeroing a pixel equal to or less than a predetermined positive threshold in the images corresponding to a specific cell type, then merging only those zeroed images and dividing the result, and subsequently applying image processing such as noise removal processing, edge enhancement processing, or the like to the merged and divided image, so enabling the guide image to have a higher S/N ratio. Thus, enabling the guide image to have a higher S/N ratio makes it possible to enhance the NR effect.

### 2-4-9. Ninth Processing Example

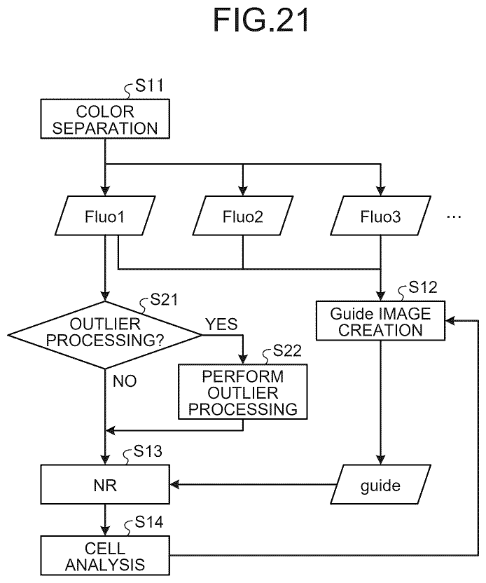

FIG. 21 is a flowchart illustrating the procedure of a ninth processing example of NR correction using a guide image according to the present embodiment.

As illustrated in FIG. 21, in the ninth processing example, in addition to the processing of the modification of the first processing example described above, the guide image generation unit 133 merges using the result of cell analysis (e.g., such as, positive cell rate or number of positive cells) as a weight during guide image creation in step S12.

According to this ninth processing example, in the case of creating the guide image, the result of cell analysis (e.g., such as positive cell rate or number of positive cells) are used as weights and merged. This enables the incorporation of cell analysis results into the guide image creation.

### 2-4-10. Tenth Processing Example

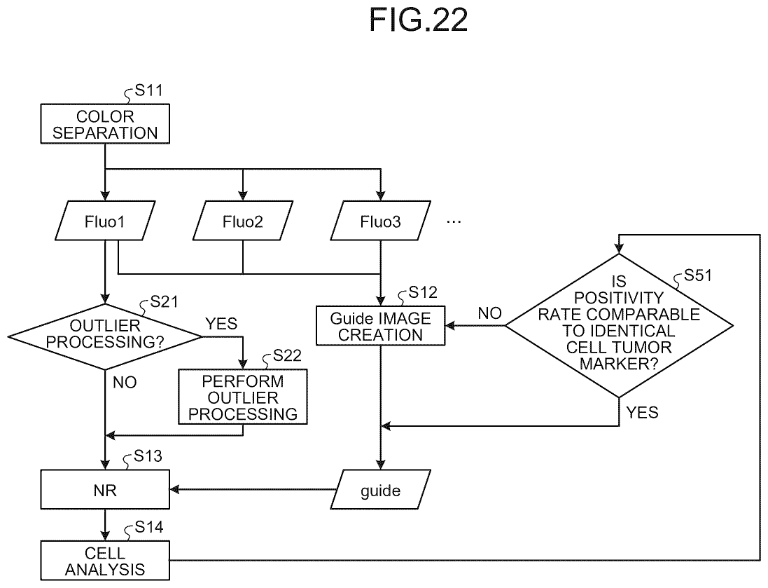

FIG. 22 is a flowchart illustrating the procedure of a tenth processing example of NR correction using a guide image according to the present embodiment.

As illustrated in FIG. 22, in the tenth processing example, in addition to the processing of the modification of the first processing example described above, in step S51, the guide image generation unit 133 determines whether the positive cell rate (positivity rate), an example of cell analysis results, is comparable or approximately equal to the positivity rate for the same cell type marker, and then, it continues to merge during the guide image creation in step S12, using the positive cell rate as a weight, until the positivity rate becomes comparable to that of the same cell type marker.

According to this tenth processing example, in the case of creating the guide image, the guide image is automatically weighted until the positive rate is the same as that of the same cell type marker, and then merged. This eliminates the need for human judgment, enabling automation.

### 2-5. Operation and Effect

As described above, according to the present embodiment, the information processing apparatus 100 includes the guide image generation unit 133 that generates a guide image for correction by summing up a plurality of images (e.g., color-separated images), each containing spectral information pertaining to a biomarker, and performing a division by the number of summed images. This configuration makes it possible to perform NR correction on the processing-target image using the guide image, thereby enabling the acquisition of a necessary signal obscured or buried in the background of the processing-target image while preserving the requisite signal intensity for analysis.

Additionally, the information processing apparatus 100 may further include the correction unit 134, which performs noise reduction correction on the processing-target image using the guide image. This configuration makes it possible to reliably obtain the necessary signal obscured or buried in the background of the processing-target image while preserving the signal intensity necessary for analysis.

Furthermore, the correction unit 134 may perform outlier processing on the processing-target image before the noise reduction correction. This configuration allows the guide image to have a higher S/N ratio, thereby enhancing the NR effect.

Further, the guide image generation unit 133 may perform image processing after summing up a plurality of images and performing a division on the result. This configuration allows the guide image to have a higher S/N ratio, thereby enhancing the NR effect.

Furthermore, the guide image generation unit 133 may perform image processing after summing up the plurality of images and before performing a division on the result. This configuration allows the guide image to have a higher S/N ratio, thereby enhancing the NR effect.

Additionally, the guide image generation unit 133 may perform processing of zeroing out a pixel that is equal to or less than a predetermined positive threshold value for a plurality of images before summing up the plurality of images. This configuration allows the guide image to have a higher S/N ratio, thereby enhancing the NR effect.

Further, the guide image generation unit 133 may perform processing of zeroing out a pixel that is equal to or less than a predetermined positive threshold for a plurality of images, and may perform image processing after summing up the plurality of images and performing a division on the result. This configuration allows the guide image to have a higher S/N ratio, thereby enhancing the NR effect.

Additionally, the guide image generation unit 133 may perform processing of zeroing out a pixel that is equal to or less than a predetermined positive threshold for a plurality of images, and may perform image processing after summing up the plurality of images and before performing a division on the result. This configuration allows the guide image to have a higher S/N ratio, thereby enhancing the NR effect.

Furthermore, the guide image generation unit 133 may sum up only images corresponding to a specific cell tumor out of the plurality of images. This configuration allows the guide image to have a higher S/N ratio, thereby enhancing the NR effect.

Further, the guide image generation unit 133 may perform image processing after summing up only images corresponding to the specific cell tumor out of the plurality of images and performing a division on the result. This configuration allows the guide image to have a higher S/N ratio, thereby enhancing the NR effect.

Furthermore, the guide image generation unit 133 may perform image processing after summing up only images corresponding to the specific cell tumor out of the plurality of images and performing a division on the result. This configuration allows the guide image to have a higher S/N ratio, thereby enhancing the NR effect.

In addition, the guide image generation unit 133 may perform zero-filling processing of zeroing a pixel equal to or less than a predetermined positive threshold on the images corresponding to the specific cell tumor out of the plurality of images, and may sum up only the images corresponding to the specific cell tumor after the zero-filling processing. This configuration allows the guide image to have a higher S/N ratio, thereby enhancing the NR effect.

Additionally, the guide image generation unit 133 may perform image processing after summing up only the images corresponding to the specific cell tumor after the zero-filling processing and performing a division on the result. This configuration allows the guide image to have a higher S/N ratio, thereby enhancing the NR effect.

Further, the guide image generation unit 133 may perform image processing after summing up only the images corresponding to the specific cell tumor after the zero-filling processing and before performing a division on the result. This configuration allows the guide image to have a higher S/N ratio, thereby enhancing the NR effect.

Furthermore, the guide image generation unit 133 may sum up a plurality of images using the analysis result for the processing-target image as a weight. This configuration enables the incorporation of analysis results (e.g., cell analysis results) into the guide image creation.

Additionally, the guide image generation unit 133 may repeatedly sum up a plurality of images using the analysis result as a weight until the analysis result becomes comparable to that of a comparison target. This eliminates the need for human judgment, enabling automation.

Further, each of the plurality of images may be a color-separated image. Even if each image is a color-separated image, it is possible to acquire a necessary signal obscured or buried in the background of the processing-target image while preserving the signal intensity necessary for analysis.

Additionally, the guide image generation unit 133 may perform image processing using a noise removal filter and an edge enhancement filter. This configuration allows the guide image to have a higher S/N ratio, thereby enhancing the NR effect.

### 3. OTHER EMBODIMENTS

The processing according to the embodiments or modifications described above may be implemented in various different forms or modifications beyond the embodiment described above. For example, out of the processing described in the embodiments mentioned above, the entirety or a part of the processing operations described as being performed automatically can be performed manually, or the processing operations described as being performed manually can also be performed manually, or the entirety or a part of the processing operations described as being performed manually can be performed automatically using known methods. In addition, unless specifically stated otherwise, the processing procedures, specific names, and information including various data and parameters illustrated in the specification and drawings can be changed optionally. For example, the various types of information illustrated in each figure is not limited to the information illustrated.

Furthermore, each component of respective apparatuses or devices illustrated in the drawings represents a functional concept and may not necessarily be configured physically as illustrated. In other words, the specific form of distributing and integrating each apparatus or device is not limited to what is illustrated in the drawings, and the entirety or a part of the apparatuses or devices can be functionally or physically distributed or integrated into optional units depending on various loads and usage conditions.

Moreover, the embodiments or modifications described above can be combined as appropriate within the range that does not conflict with the processing details. Furthermore, the effects described in this specification are merely exemplary and are not limited, and other effects also be achievable.

### 4. APPLICATION EXAMPLE

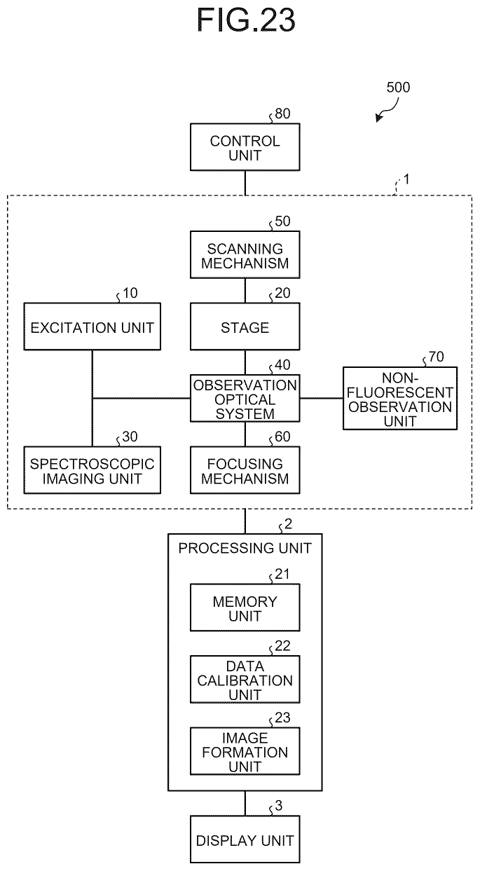

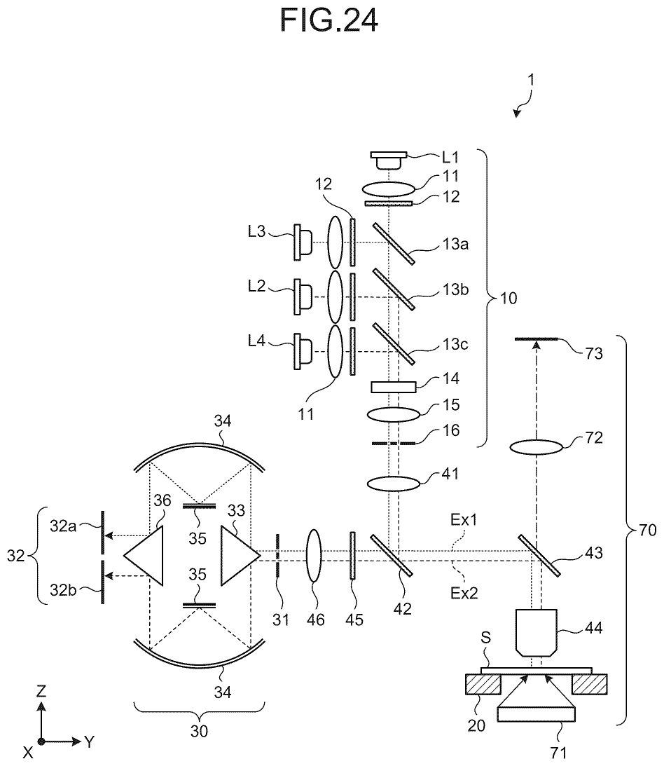

The technology according to the present disclosure can be applied to, for example, a fluorescence observation apparatus 500 (an example of a microscope system) or the like. Hereinafter, a configuration example of an applicable fluorescence observation apparatus 500 will be described with reference to FIGS. 23 and 24. FIG. 23 is a diagram showing an example of a schematic configuration of the fluorescence observation apparatus 500 according to the present embodiment. FIG. 24 is a diagram showing an example of a schematic configuration of an observation unit 1 according to the present embodiment.

As shown in FIG. 23, the fluorescence observation apparatus 500 includes the observation unit 1, a process unit 2, and a display unit 3.

The observation unit 1 includes an excitation unit (irradiation unit) 10, a stage 20, a spectral imaging unit 30, an observation optical system 40, a scanning mechanism 50, a focus mechanism 60, and a non-fluorescence observing unit 70.

The excitation unit 10 irradiates the observation target with a plurality of beams of irradiation light having different wavelengths. For example, the excitation unit 10 irradiates a pathological specimen (pathological sample), which is the observation target, with a plurality of line illuminations having different wavelengths arranged in parallel with different axes. The stage 20 is a table that supports the pathological specimen, and is configured to be movable in a direction perpendicular to the direction of line light by the line illuminations by the scanning mechanism 50. The spectral imaging unit 30 includes a spectroscope and acquires a fluorescence spectrum (spectroscopic data) of the pathological specimen excited linearly by the line illuminations.

That is, the observation unit 1 functions as a line spectroscope that acquires spectroscopic data corresponding to the line illuminations. Further, the observation unit 1 also functions as an imaging device that captures a plurality of fluorescence images generated by an imaging target (pathological specimen) for each of a plurality of fluorescence wavelengths for each line and acquires data of the plurality of captured fluorescence images in an arrangement order of the lines.

Here, parallel with different axis means that the plurality of line illuminations has different axes and are parallel. The different axes mean that the axes are not coaxial, and the distance between the axes is not particularly limited. The parallel is not limited to parallel in a strict sense, and includes a state of being substantially parallel. For example, there may be distortion originated from an optical system such as a lens or deviation from a parallel state due to manufacturing tolerance, and this case is also regarded as parallel.

The excitation unit 10 and the spectral imaging unit 30 are connected to the stage 20 via the observation optical system 40. The observation optical system 40 has a function of following an optimum focus by the focus mechanism 60. The non-fluorescence observing unit 70 for performing dark field observation, bright field observation, and the like may be connected to the observation optical system 40. In addition, a control unit 80 that controls the excitation unit 10, the spectral imaging unit 30, the scanning mechanism 50, the focus mechanism 60, the non-fluorescence observing unit 70, and the like may be connected to the observation unit 1.

The process unit 2 includes a storing unit 21, a data calibration unit 22, and an image formation unit 23. The process unit 2 typically forms an image of the pathological specimen or outputs a distribution of the fluorescence spectrum on the basis of the fluorescence spectrum of the pathological specimen (hereinafter also referred to as a sample S) acquired by the observation unit 1. The image referred to herein refers to a constituent ratio of autofluorescence derived from a dye or a sample, or the like constituting the spectrum, an image converted from waveforms into RGB (red, green, and blue) color, a luminance distribution in a specific wavelength band, and the like.

The storing unit 21 includes a nonvolatile storage medium such as a hard disk drive or a flash memory, and a storage control unit that controls writing and reading of data to and from the storage medium. The storing unit 21 stores spectroscopic data indicating a correlation between each wavelength of light emitted by each of the plurality of line illuminations included in the excitation unit 10 and fluorescence received by the camera of the spectral imaging unit 30. Further, the storing unit 21 stores in advance information indicating a standard spectrum of autofluorescence related to a sample (pathological specimen) to be observed and information indicating a standard spectrum of a single dye staining the sample.

The data calibration unit 22 configures the spectroscopic data stored in the storing unit 21 on the basis of the captured image captured by the camera of the spectral imaging unit 30. The image formation unit 23 forms a fluorescence image of the sample on the basis of the spectroscopic data and an interval Δy of the plurality of line illuminations irradiated by the excitation unit 10. For example, the process unit 2 including the data calibration unit 22, the image formation unit 23, and the like is implemented by hardware elements used in a computer such as a central processing unit (CPU), a random access memory (RAM), and a read only memory (ROM), and a necessary program (software). Instead of or in addition to the CPU, a programmable logic device (PLD) such as a field programmable gate array (FPGA), a digital signal processor (DSP), an application specific integrated circuit (ASIC), or the like may be used.

The display unit 3 displays, for example, various types of information such as an image based on the fluorescence image formed by the image formation unit 23. The display unit 3 may include, for example, a monitor integrally attached to the process unit 2, or may be a display device connected to the process unit 2. The display unit 3 includes, for example, a display element such as a liquid crystal device or an organic EL device, and a touch sensor, and is configured as a user interface (UI) that displays input settings of image-capturing conditions, a captured image, and the like.

Next, details of the observation unit 1 will be described with reference to FIG. 24. Here, a description will be given on the assumption that the excitation unit 10 includes two line illuminations Ex1 and Ex2 that each emit light of two wavelengths. For example, the line illumination Ex1 emits light having a wavelength of 405 nm and light having a wavelength of 561 nm, and the line illumination Ex2 emits light having a wavelength of 488 nm and light having a wavelength of 645 nm.

As shown in FIG. 24, the excitation unit 10 includes a plurality of excitation light sources L1, L2, L3, and L4 (four excitation light sources in this example). Each of the excitation light sources L1 to L4 includes a laser light source that outputs laser light having a wavelength of 405 nm, 488 nm, 561 nm, and 645 nm, respectively. For example, each of the excitation light sources L1 to L4 includes a light emitting diode (LED), a laser diode (LD), or the like.

Furthermore, the excitation unit 10 includes a plurality of collimator lenses 11, a plurality of laser line filters 12, a plurality of dichroic mirrors 13a, 13b, and 13c, a homogenizer 14, a condenser lens 15, and an incident slit 16 so as to correspond to each of the excitation light sources L1 to L4.

The laser light emitted from the excitation light source L1 and the laser light emitted from the excitation light source L3 are collimated by the collimator lens 11, transmitted through the laser line filter 12 for cutting a skirt of each wavelength band, and made coaxial by the dichroic mirror 13a. The two coaxial laser lights are further beam-shaped by the homogenizer 14 such as a fly-eye lens and the condenser lens 15 so as to be the line illumination Ex1.

Similarly, the laser light emitted from the pumping light source L2 and the laser light emitted from the excitation light source L4 are coaxial by the dichroic mirrors 13b and 13c, and line illumination is performed so that the line illumination Ex2 is different in axis from the line illumination Ex1. The line illuminations Ex1 and Ex2 form line illuminations with different axes (primary image), which are separated by a distance Δy in the incident slit 16 (slit conjugate) having a plurality of slit portions through which each of the line illuminations Ex1 and Ex2 can pass.

Note that, in the present embodiment, an example in which the four lasers have two coaxial axes and two different axes will be described, but in addition to this, the two lasers may have two different axes or the four lasers may have four different axes.

The sample S on the stage 20 is irradiated with the primary image via the observation optical system 40. The observation optical system 40 includes a condenser lens 41, dichroic mirrors 42 and 43, an objective lens 44, a band pass filter 45, and a condenser lens (an example of an imaging lens) 46. The line illuminations Ex1 and Ex2 are collimated by the condenser lens 41 paired with the objective lens 44, reflected by the dichroic mirrors 42 and 43, transmitted through the objective lens 44, and irradiates the sample S on the stage 20.

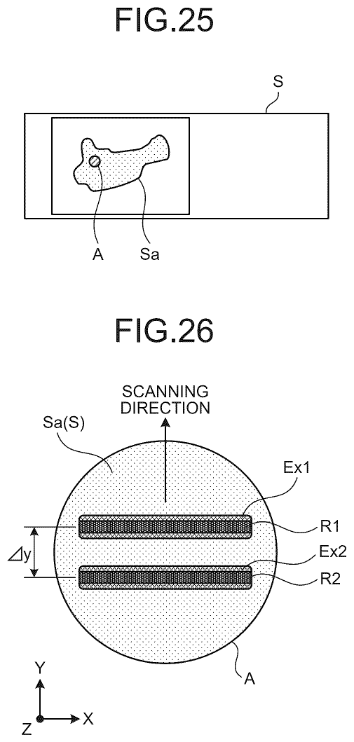

Here, FIG. 25 is a diagram showing an example of the sample S according to the present embodiment. FIG. 25 shows a state in which the sample S is viewed from the irradiation directions of the line illuminations Ex1 and Ex2 as excitation light. The sample S is typically configured by a slide including an observation target Sa such as a tissue section as shown in FIG. 25, but may be of course other than that. The observation target Sa is, for example, a biological sample such as a nucleic acid, a cell, a protein, a bacterium, or a virus. The sample S (observation target Sa) is stained with a plurality of fluorescent dyes. The observation unit 1 enlarges and observes the sample S at a desired magnification.

FIG. 26 is an enlarged diagram showing a region A in which the sample S according to the present embodiment is irradiated with the line illuminations Ex1 and Ex2. In the example of FIG. 26, two line illuminations Ex1 and Ex2 are arranged in the region A, and imaging areas R1 and R2 of the spectral imaging unit 30 are arranged so as to overlap the line illuminations Ex1 and Ex2. The two line illuminations Ex1 and Ex2 are each parallel to a Z-axis direction and are arranged apart from each other by a predetermined distance Δy in a Y-axis direction.

The line illuminations Ex1 and Ex2 are formed on the surface of the sample S as shown in FIG. 26. As shown in FIG. 24, fluorescence excited in the sample S by the line illuminations Ex1 and Ex2 is condensed by the objective lens 44, reflected by the dichroic mirror 43, transmitted through the dichroic mirror 42 and the band pass filter 45 that cuts off the excitation light, condensed again by the condenser lens 46, and incident on the spectral imaging unit 30.

As shown in FIG. 24, the spectral imaging unit 30 includes an observation slit (opening) 31, an imaging element 32, a first prism 33, a mirror 34, a diffraction grating 35 (wavelength dispersion element), and a second prism 36.

In the example of FIG. 24, the imaging element 32 includes two imaging elements 32a and 32b. The imaging element 32 captures (receives) a plurality of light beams (fluorescence and the like) wavelength-dispersed by the diffraction grating 35. As the imaging element 32, for example, a two-dimensional imager such as a charge coupled device (CCD) or a complementary metal oxide semiconductor (CMOS) is employed.

The observation slit 31 is disposed at the condensing point of the condenser lens 46, and has the same number of (two this example) slit portions as the number of excitation lines. The fluorescence spectra derived from the two excitation lines that have passed through the observation slit 31 are separated by the first prism 33 and reflected by a grating surface of the diffraction grating 35 via the mirror 34, so that the fluorescence spectra are further separated into fluorescence spectra of respective excitation wavelengths. The four separated fluorescence spectra are incident on the imaging elements 32a and 32b via the mirror 34 and the second prism 36, and are developed as spectroscopic data into spectroscopic data (x, λ) expressed by the position x in the line direction and the wavelength λ. The spectroscopic data (x, λ) is a pixel value of a pixel at a position x in a row direction and at a position of a wavelength λ in a column direction among pixels included in the imaging element 32. Note that the spectroscopic data (x, λ) may be simply described as spectroscopic data.

Note that the pixel size (nm/Pixel) of the imaging elements 32a and 32b is not particularly limited, and is set, for example, equal to or more than 2 (nm/Pixel) and equal to or less than 20 (nm/Pixel). This dispersion value may be achieved optically or at a pitch of the diffraction grating 35, or may be achieved by using hardware binning of the imaging elements 32a and 32b. In addition, the dichroic mirror 42 and the band pass filter 45 are inserted in the middle of the optical path so that the excitation light (line illuminations Ex1 and Ex2) does not reach the imaging element 32.

Each of the line illuminations Ex1 and Ex2 is not limited to the case of being configured with a single wavelength, and each may be configured with a plurality of wavelengths. When the line illuminations Ex1 and Ex2 are each formed by a plurality of wavelengths, the fluorescence excited by these also includes a plurality of spectra. In this case, the spectral imaging unit 30 includes a wavelength dispersion element for separating the fluorescence into a spectrum derived from the excitation wavelength. The wavelength dispersion element includes a diffraction grating, a prism, or the like, and is typically disposed on an optical path between the observation slit 31 and the imaging element 32.

Note that the stage 20 and the scanning mechanism 50 constitute an X-Y stage, and move the sample S in the X-axis direction and the Y-axis direction in order to acquire a fluorescence image of the sample S. In the whole slide imaging (WSI), an operation of scanning the sample S in the Y-axis direction, then moving the sample S in the X-axis direction, and further performing scanning in the Y-axis direction is repeated. By using the scanning mechanism 50, it is possible to continuously acquire dye spectra (fluorescence spectra) excited at different excitation wavelengths, which are spatially separated by the distance Δy on the sample S (observation target Sa) in the Y-axis direction.

The scanning mechanism 50 changes the position irradiated with the irradiation light in the sample S over time. For example, the scanning mechanism 50 scans the stage 20 in the Y-axis direction. The scanning mechanism 50 can cause the stage 20 to scan the plurality of line illuminations Ex1 and Ex2 in the Y-axis direction, that is, in the arrangement direction of the line illuminations Ex1 and Ex2. This is not limited to this example, and the plurality of line illuminations Ex1 and Ex2 may be scanned in the Y-axis direction by a galvano mirror disposed in the middle of the optical system. Since the data derived from each of the line illuminations Ex1 and Ex2 (for example, the two-dimensional data or the three-dimensional data) is data whose coordinates are shifted by the distance Δy with respect to the Y axis, the data is corrected and output on the basis of the distance Δy stored in advance or the value of the distance Δy calculated from the output of the imaging element 32.

As shown in FIG. 24, the non-fluorescence observing unit 70 includes a light source 71, the dichroic mirror 43, the objective lens 44, a condenser lens 72, an imaging element 73, and the like. In the non-fluorescence observing unit 70, an observation system by dark field illumination is shown in the example of FIG. 24.

The light source 71 is disposed on the side facing the objective lens 44 with respect to the stage 20, and irradiates the sample S on the stage 20 with illumination light from the side opposite to the line illuminations Ex1 and Ex2. In a case of the dark field illumination, the light source 71 illuminates from the outside of the NA (numerical aperture) of the objective lens 44, and light (dark field image) diffracted by the sample S is imaged by the imaging element 73 via the objective lens 44, the dichroic mirror 43, and the condenser lens 72. By using dark field illumination, even a apparently transparent sample such as a fluorescently-stained sample can be observed with contrast.

Note that this dark field image may be observed simultaneously with fluorescence and used for real-time focusing. In this case, as the illumination wavelength, a wavelength that does not affect fluorescence observation may be selected. The non-fluorescence observing unit 70 is not limited to the observation system that acquires a dark field image, and may be configured by an observation system that can acquire a non-fluorescence image such as a bright field image, a phase difference image, a phase image, and an in-line hologram image. For example, as a method for acquiring a non-fluorescence image, various observation methods such as a Schlieren method, a phase difference contrast method, a polarization observation method, and an epi-illumination method can be employed. The position of the illumination light source is not limited to below the stage 20, and may be above the stage 20 or around the objective lens 44. In addition, not only a method of performing focus control in real time, but also another method such as a prefocus map method of recording focus coordinates (Z coordinates) in advance may be employed.

Note that, in the above description, the line illumination as the excitation light includes two line illuminations Ex1 and Ex2 but is not limited thereto, and may be three, four, or five or more. In addition, each line illumination may include a plurality of excitation wavelengths selected so that the color separation performance is not degraded as much as possible. Further, even if there is one line illumination, if it is an excitation light source including a plurality of excitation wavelengths and each excitation wavelength is recorded in association with the data acquired by the imaging element 32, it is possible to obtain a polychromatic spectrum although it is not possible to obtain separability to be parallel to different axes.

The application example in which the technology according to the present disclosure is applied to the fluorescence observation apparatus 500 has been described above. Note that the above-described configuration described with reference to FIGS. 23 and 24 is merely an example, and the configuration of the fluorescence observation apparatus 500 according to the present embodiment is not limited to such an example. For example, the fluorescence observation apparatus 500 may not necessarily include all of the configurations shown in FIGS. 23 and 24, and may include a configuration not shown in FIGS. 23 and 24.

### 5. APPLICATION EXAMPLE

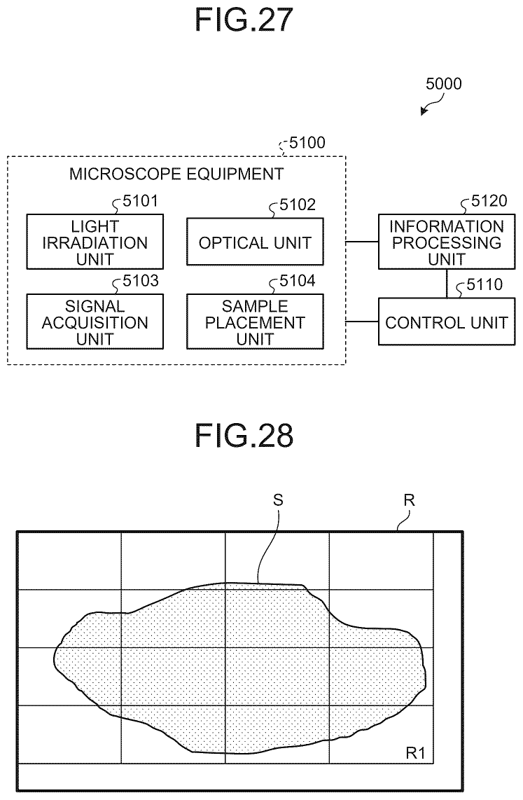

The technology according to the present disclosure can be applied to, for example, a microscope system and the like. Hereinafter, a configuration example of a microscope system 5000 that can be applied will be described with reference to FIGS. 27 to 29. A microscope device 5100 which is a part of the microscope system 5000 functions as an imaging device.

FIG. 27 shows an example configuration of a microscope system of the present disclosure. A microscope system 5000 shown in FIG. 27 includes a microscope device 5100, a control unit 5110, and an information processing unit 5120. The microscope device 5100 includes a light irradiation unit 5101, an optical unit 5102, and a signal acquisition unit 5103. The microscope device 5100 may further include a sample placement unit 5104 on which a biological sample S is placed. Note that the configuration of the microscope device 5100 is not limited to that shown in FIG. 27. For example, the light irradiation unit 5101 may exist outside the microscope device 5100, and a light source not included in the microscope device 5100 may be used as the light irradiation unit 5101. Alternatively, the light irradiation unit 5101 may be disposed so that the sample placement unit 5104 is sandwiched between the light irradiation unit 5101 and the optical unit 5102, and may be disposed on the side at which the optical unit 5102 exists, for example. The microscope device 5100 may be designed to be capable of performing one or more of the following: bright-field observation, phase contrast observation, differential interference contrast observation, polarization observation, fluorescent observation, and darkfield observation.

The microscope system 5000 may be designed as a so-called whole slide imaging (WSI) system or a digital pathology imaging system, and can be used for pathological diagnosis. Alternatively, the microscope system 5000 may be designed as a fluorescence imaging system, or particularly, as a multiple fluorescence imaging system.

For example, the microscope system 5000 may be used to make an intraoperative pathological diagnosis or a telepathological diagnosis. In the intraoperative pathological diagnosis, the microscope device 5100 can acquire the data of the biological sample S acquired from the subject of the operation while the operation is being performed, and then transmit the data to the information processing unit 5120. In the telepathological diagnosis, the microscope device 5100 can transmit the acquired data of the biological sample S to the information processing unit 5120 located in a place away from the microscope device 5100 (such as in another room or building). In these diagnoses, the information processing unit 5120 then receives and outputs the data. On the basis of the output data, the user of the information processing unit 5120 can make a pathological diagnosis.

### (Biological Sample)

The biological sample S may be a sample containing a biological component. The biological component may be a tissue, a cell, a liquid component of the living body (blood, urine, or the like), a culture, or a living cell (a myocardial cell, a nerve cell, a fertilized egg, or the like). The biological sample may be a solid, or may be a specimen fixed with a fixing reagent such as paraffin or a solid formed by freezing. The biological sample can be a section of the solid. A specific example of the biological sample may be a section of a biopsy sample.

The biological sample may be one that has been subjected to a treatment such as staining or labeling. The treatment may be staining for indicating the morphology of the biological component or for indicating the substance (surface antigen or the like) contained in the biological component, and can be hematoxylin-eosin (HE) staining or immunohistochemistry staining, for example. The biological sample may be one that has been subjected to the above treatment with one or more reagents, and the reagent(s) can be a fluorescent dye, a coloring reagent, a fluorescent protein, or a fluorescence-labeled antibody.

The specimen may be prepared from a tissue sample for the purpose of pathological diagnosis or clinical examination. Alternatively, the specimen is not necessarily of the human body, and may be derived from an animal, a plant, or some other material. The specimen may differ in property, depending on the type of the tissue being used (such as an organ or a cell, for example), the type of the disease being examined, the attributes of the subject (such as age, gender, blood type, and race, for example), or the subject's daily habits (such as an eating habit, an exercise habit, and a smoking habit, for example). The specimen may be accompanied by identification information (bar code, QR code (registered trademark), or the like) for identifying each specimen, and be managed in accordance with the identification information.

### (Light Irradiation Unit)

The light irradiation unit 5101 is a light source for illuminating the biological sample S, and is an optical unit that guides light emitted from the light source to a specimen. The light source can illuminate a biological sample with visible light, ultraviolet light, infrared light, or a combination thereof. The light source may be one or more of the following: a halogen light source, a laser light source, an LED light source, a mercury light source, and a xenon light source. The light source in fluorescent observation may be of a plurality of types and/or wavelengths, and the types and the wavelengths may be appropriately selected by a person skilled in the art. The light irradiation 5101 unit may have a configuration of a transmissive type, a reflective type, or an epi-illumination type (a coaxial epi-illumination type or a side-illumination type).

### (Optical Unit)

The optical unit 5102 is designed to guide the light from the biological sample S to the signal acquisition unit 5103. The optical unit 5102 may be designed to enable the microscope device 5100 to observe or capture an image of the biological sample S. The optical unit 5102 may include an objective lens. The type of the objective lens may be appropriately selected by a person skilled in the art, in accordance with the observation method. The optical unit 5102 may also include a relay lens for relaying an image magnified by the objective lens to the signal acquisition unit 5103. The optical unit 5102 may further include optical components other than the objective lens and the relay lens, and the optical components may be an eyepiece, a phase plate, a condenser lens, and the like. The optical unit 5102 may further include a wavelength separation unit designed to separate light having a predetermined wavelength from the light from the biological sample S. The wavelength separation unit may be designed to selectively cause light having a predetermined wavelength or a predetermined wavelength range to reach the signal acquisition unit 5103. The wavelength separation unit may include one or more of the following: a filter, a polarizing plate, a prism (Wollaston prism), and a diffraction grating that selectively pass light, for example. The optical component(s) included in the wavelength separation unit may be disposed in the optical path from the objective lens to the signal acquisition unit 5103, for example. The wavelength separation unit is provided in the microscope device 5100 in a case where fluorescent observation is performed, or particularly, where an excitation light irradiation unit is included. The wavelength separation unit may be designed to separate fluorescence or white light from fluorescence.

### (Signal Acquisition Unit)

The signal acquisition unit 5103 may be designed to receive light from the biological sample S, and convert the light into an electrical signal, or particularly, into a digital electrical signal. The signal acquisition unit 5103 may be designed to be capable of acquiring data about the biological sample S, on the basis of the electrical signal. The signal acquisition unit 5103 may be designed to be capable of acquiring data of an image (a captured image, or particularly, a still image, a time-lapse image, or a moving image) of the biological sample S, or particularly, may be designed to acquire data of an image enlarged by the optical unit 5102. The signal acquisition unit 5103 includes one or more image sensors, CMOSs, CCDs, or the like that include a plurality of pixels arranged in one- or two-dimensional manner. The signal acquisition unit 5103 may include an image sensor for acquiring a low-resolution image and an image sensor for acquiring a high-resolution image, or may include an image sensor for sensing for AF or the like and an image sensor for outputting an image for observation or the like. The image sensor may include not only the plurality of pixels, but also a signal processing unit (including one or more of the following: a CPU, a DSP, and a memory) that performs signal processing using pixel signals from the respective pixels, and an output control unit that controls outputting of image data generated from the pixel signals and processed data generated by the signal processing unit. The image sensor including the plurality of pixels, the signal processing unit, and the output control unit can be preferably designed as a one-chip semiconductor device. Note that the microscope system 5000 may further include an event detection sensor. The event detection sensor includes a pixel that photoelectrically converts incident light, and may be designed to detect that a change in the luminance of the pixel exceeds a predetermined threshold, and regard the change as an event. The event detection sensor may be of an asynchronous type.

### (Control Unit)

The control unit 5110 controls imaging being performed by the microscope device 5100. For the imaging control, the control unit 5110 can drive movement of the optical unit 5102 and/or the sample placement unit 5104, to adjust the positional relationship between the optical unit 5102 and the sample placement unit 5104. The control unit 5110 can move the optical unit 5102 and/or the sample placement unit 5104 in a direction toward or away from each other (in the optical axis direction of the objective lens, for example). The control unit 5110 may also move the optical unit 5102 and/or the sample placement unit 5104 in any direction in a plane perpendicular to the optical axis direction. For the imaging control, the control unit 5110 may control the light irradiation unit 5101 and/or the signal acquisition unit 5103.

### (Sample Placement Unit)

The sample placement unit 5104 may be designed to be capable of securing the position of a biological sample on the sample placement unit 5104, and may be a so-called stage. The sample placement unit 5104 may be designed to be capable of moving the position of the biological sample in the optical axis direction of the objective lens and/or in a direction perpendicular to the optical axis direction.

### (Information Processing Unit)

The information processing unit 5120 can acquire, from the microscope device 5100, data (imaging data or the like) acquired by the microscope device 5100. The information processing unit 5120 can perform image processing on the imaging data. The image processing may include an unmixing process, or more specifically, a spectral unmixing process. The unmixing process may include a process of extracting data of the optical component of a predetermined wavelength or in a predetermined wavelength range from the imaging data to generate image data, or a process of removing data of the optical component of a predetermined wavelength or in a predetermined wavelength range from the imaging data. The image processing may also include an autofluorescence separation process for separating the autofluorescence component and the dye component of a tissue section, and a fluorescence separation process for separating wavelengths between dyes having different fluorescence wavelengths from each other. The autofluorescence separation process may include a process of removing the autofluorescence component from image information about another specimen, using an autofluorescence signal extracted from one specimen of the plurality of specimens having the same or similar properties. The information processing unit 5120 may transmit data for the imaging control to the control unit 5110, and the control unit 5110 that has received the data may control the imaging being by the microscope device 5100 in accordance with the data.

The information processing unit 5120 may be designed as an information processing device such as a general-purpose computer, and may include a CPU, RAM, and ROM. The information processing unit 5120 may be included in the housing of the microscope device 5100, or may be located outside the housing. Further, the various processes or functions to be executed by the information processing unit 5120 may be realized by a server computer or a cloud connected via a network.

The method to be implemented by the microscope device 5100 to capture an image of the biological sample S may be appropriately selected by a person skilled in the art, in accordance with the type of the biological sample, the purpose of imaging, and the like. Examples of the imaging method are described below.

One example of the imaging method is as follows. The microscope device 5100 can first identify an imaging target region. The imaging target region may be identified so as to cover the entire region in which the biological sample exists, or may be identified so as to cover the target portion (the portion in which the target tissue section, the target cell, or the target lesion exists) of the biological sample. Next, the microscope device 5100 divides the imaging target region into a plurality of divided regions of a predetermined size, and the microscope device 5100 sequentially captures images of the respective divided regions. As a result, an image of each divided region is acquired.

As shown in FIG. 28, the microscope device 5100 identifies an imaging target region R that covers the entire biological sample S. The microscope device 5100 then divides the imaging target region R into 16 divided regions. The microscope device 5100 then captures an image of a divided region R1, and next captures one of the regions included in the imaging target region R, such as an image of a region adjacent to the divided region R1. After that, divided region imaging is performed until images of all the divided regions have been captured. Note that an image of a region other than the imaging target region R may also be captured on the basis of captured image information about the divided regions. The positional relationship between the microscope device 5100 and the sample placement unit 5104 is adjusted so that an image of the next divided region is captured after one divided region is captured. The adjustment may be performed by moving the microscope device 5100, moving the sample placement unit 5104, or moving both. In this example, the imaging device that captures an image of each divided region may be a two-dimensional image sensor (an area sensor) or a one-dimensional image sensor (a line sensor). The signal acquisition unit 5103 may capture an image of each divided region via the optical unit 5102. Further, images of the respective divided regions may be continuously captured while the microscope device 5100 and/or the sample placement unit 5104 is moved, or movement of the microscope device 5100 and/or the sample placement unit 5104 may be stopped every time an image of a divided region is captured. The imaging target region may be divided so that the respective divided regions partially overlap, or the imaging target region may be divided so that the respective divided regions do not overlap. A plurality of images of each divided region may be captured while the imaging conditions such as the focal length and/or the exposure time are changed. The information processing device can also generate image data of a wider region by stitching a plurality of adjacent divided regions. As the stitching process is performed on the entire imaging target region, an image of a wider region can be acquired with respect to the imaging target region. Also, image data with a lower resolution can be generated from the images of the divided regions or the images subjected to the stitching process.

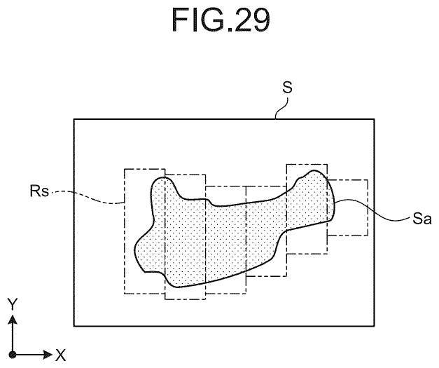

Another example of the imaging method is as follows. The microscope device 5100 can first identify an imaging target region. The imaging target region may be identified so as to cover the entire region in which the biological sample exists, or may be identified so as to cover the target portion (the portion in which the target tissue section or the target cell exists) of the biological sample. Next, the microscope device 5100 scans a region (also referred to as a “divided scan region”) of the imaging target region in one direction (also referred to as a “scan direction”) in a plane perpendicular to the optical axis, and thus captures an image. After the scanning of the divided scan region is completed, the divided scan region next to the scan region is then scanned. These scanning operations are repeated until an image of the entire imaging target region is captured. As shown in FIG. 29, the microscope device 5100 identifies a region (a gray portion) in which a tissue section of the biological sample S exists, as an imaging target region Sa. The microscope device 5100 then scans a divided scan region Rs of the imaging target region Sa in the Y-axis direction. After completing the scanning of the divided scan region Rs, the microscope device 5100 then scans the divided scan region that is the next in the X-axis direction. This operation is repeated until scanning of the entire imaging target region Sa is completed. For the scanning of each divided scan region, the positional relationship between the microscope device 5100 and the sample placement unit 5104 is adjusted so that an image of the next divided scan region is captured after an image of one divided scan region is captured. The adjustment may be performed by moving the microscope device 5100, moving the sample placement unit 5104, or moving both. In this example, the imaging device that captures an image of each divided scan region may be a one-dimensional image sensor (a line sensor) or a two-dimensional image sensor (an area sensor). The signal acquisition unit 5103 may capture an image of each divided region via a magnifying optical system. Also, images of the respective divided scan regions may be continuously captured while the microscope device 5100 and/or the sample placement unit 5104 is moved. The imaging target region may be divided so that the respective divided scan regions partially overlap, or the imaging target region may be divided so that the respective divided scan regions do not overlap. A plurality of images of each divided scan region may be captured while the imaging conditions such as the focal length and/or the exposure time are changed. The information processing device can also generate image data of a wider region by stitching a plurality of adjacent divided scan regions. As the stitching process is performed on the entire imaging target region, an image of a wider region can be acquired with respect to the imaging target region. Also, image data with a lower resolution can be generated from the images of the divided scan regions or the images subjected to the stitching process.

### 6. CONFIGURATION EXAMPLE OF HARDWARE

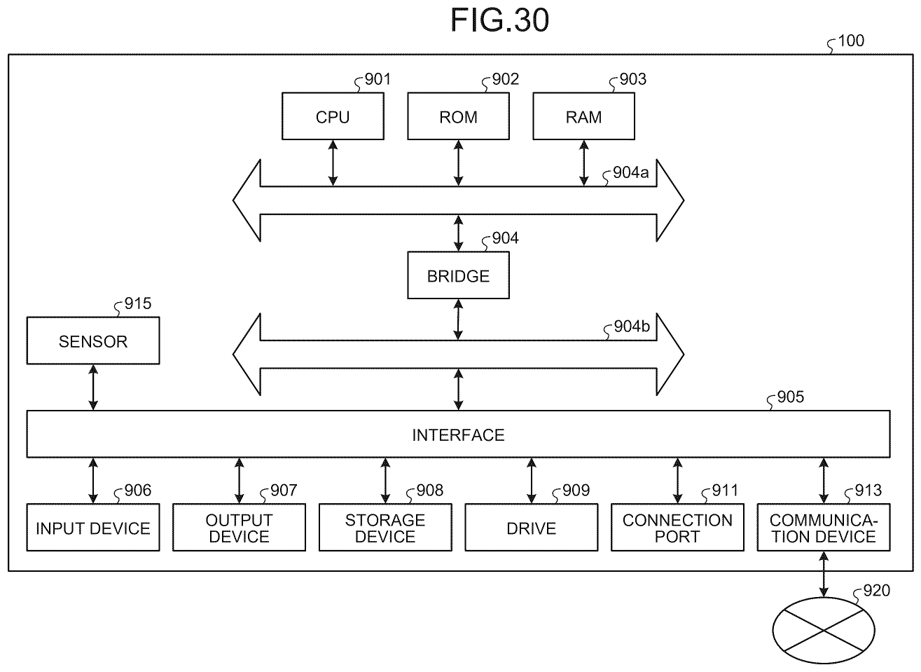

A hardware configuration example of the information processing device 100 according to each embodiment (or each modification) will be described with reference to FIG. 30. FIG. 30 is a block diagram showing an example of a schematic configuration of hardware of the information processing device 100. Various processes by the information processing device 100 are implemented, for example, by cooperation of software and hardware described below.

As shown in FIG. 30, the information processing device 100 includes a central processing unit (CPU) 901, a read only memory (ROM) 902, a random access memory (RAM) 903, and a host bus 904a. Furthermore, the information processing device 100 includes a bridge 904, an external bus 904b, an interface 905, an input device 906, an output device 907, a storage device 908, a drive 909, a connection port 911, a communication device 913, and a sensor 915. The information processing device 100 may include a processing circuit such as a DSP or an ASIC instead of or in addition to the CPU 901.

The CPU 901 functions as an arithmetic processing device and a control device, and controls the overall operation in the information processing device 100 according to various programs. In addition, the CPU 901 may be a microprocessor. The ROM 902 stores programs, operation parameters, and the like used by the CPU 901. The RAM 903 primarily stores programs used in the execution of the CPU 901, parameters that appropriately change in the execution, and the like. The CPU 901 can embody, for example, at least the processing unit 130 and the control unit 150 of the information processing device 100.

The CPU 901, the ROM 902, and the RAM 903 are mutually connected by a host bus 904a including a CPU bus and the like. The host bus 904a is connected to the external bus 904b such as a peripheral component interconnect/interface (PCI) bus via the bridge 904. Note that the host bus 904a, the bridge 904, and the external bus 904b do not necessarily need to be configured separately, and these functions may be mounted on one bus.

The input device 906 is implemented by, for example, a device to which information is input by an implementer, such as a mouse, a keyboard, a touch panel, a button, a microphone, a switch, and a lever. Furthermore, the input device 906 may be, for example, a remote control device using infrared rays or other radio waves, or may be an external connection device such as a mobile phone or a PDA corresponding to the operation of the information processing device 100. Furthermore, the input device 906 may include, for example, an input control circuit that generates an input signal on the basis of information input by the implementer using the above input units and outputs the input signal to the CPU 901. By operating the input device 906, the implementer can input various data to the information processing device and instruct the information processing device 100 to perform a processing operation. The input device 906 can embody at least the operating unit 160 of the information processing device 100, for example.

The output device 907 is formed by a device capable of visually or audibly notifying the implementer of acquired information. Examples of such a device include a display device such as a CRT display device, a liquid crystal display device, a plasma display device, an EL display device, and a lamp, a sound output device such as a speaker and a headphone, and a printer device. The output device 907 can embody at least the display unit 140 of the information processing device 100, for example.

The storage device 908 is a device for storing data. The storage device 908 is achieved by, for example, a magnetic storage device such as an HDD, a semiconductor storage device, an optical storage device, a magneto-optical storage device, or the like. The storage device 908 may include a storage medium, a recording device that records data in the storage medium, a reading device that reads data from the storage medium, a deletion device that deletes data recorded in the storage medium, and the like. The storage device 908 stores programs and various data executed by the CPU 901, various data acquired from the outside, and the like. The storage device 908 can embody at least the storage unit 120 of the information processing device 100, for example.

The drive 909 is a reader/writer for a storage medium, and is built in or externally attached to the information processing device 100. The drive 909 reads information recorded in a removable storage medium such as a mounted magnetic disk, optical disk, magneto-optical disk, or semiconductor memory, and outputs the information to the RAM 903. Furthermore, the drive 909 can also write information to a removable storage medium.

The connection port 911 is an interface connected to an external device, and is a connection port to an external device capable of transmitting data by, for example, a universal serial bus (USB).

The communication device 913 is, for example, a communication interface formed by a communication device or the like for connecting to the network 920. The communication device 913 is, for example, a communication card for wired or wireless local area network (LAN), long term evolution (LTE), Bluetooth (registered trademark), wireless USB (WUSB), or the like. Furthermore, the communication device 913 may be a router for optical communication, a router for asymmetric digital subscriber line (ADSL), a modem for various types of communication, or the like. For example, the communication device 913 can transmit and receive signals and the like to and from the Internet and other communication devices according to a predetermined protocol such as TCP/IP.

In the present embodiment, the sensor 915 includes a sensor capable of acquiring a spectrum (for example, an imaging element or the like), but may include another sensor (for example, an acceleration sensor, a gyro sensor, a geomagnetic sensor, a pressure-sensitive sensor, a sound sensor, a distance measuring sensor, or the like). The sensor 915 can embody at least the image acquisition unit 112 of the information processing device 100, for example.

Note that the network 920 is a wired or wireless transmission path of information transmitted from a device connected to the network 920. For example, the network 920 may include a public network such as the Internet, a telephone network, or a satellite communication network, various local area networks (LANs) including Ethernet (registered trademark), a wide area network (WAN), or the like. In addition, the network 920 may include a dedicated line network such as an Internet protocol-virtual private network (IP-VPN).

The hardware configuration example capable of implementing the functions of the information processing device 100 has been described above. Each of the above-described components may be implemented using a general-purpose member, or may be implemented by hardware specialized for the function of each component. Therefore, it is possible to appropriately change the hardware configuration to be used according to the technical level at the time of implementing the present disclosure.

Note that a computer program for implementing each function of the information processing device 100 as described above can be created and mounted on a PC or the like. Furthermore, it is also possible to provide a computer-readable recording medium storing such a computer program. The recording medium is, for example, a magnetic disk, an optical disk, a magneto-optical disk, a flash memory, or the like. In addition, the computer program described above may be distributed via, for example, a network without using the recording medium.

### 7. ADDITIONAL NOTES

Moreover, the present technology can also have the following configurations.

(1)

An information processing apparatus comprising:

a guide image generation unit configured to sum up a plurality of images each including spectral information regarding a biomarker, and perform a division on a result by a number of summed images to generate a guide image for correction.

(2)

The information processing apparatus according to (1), further comprising:

a correction unit configured to perform noise reduction correction on a processing-target image using the guide image.

(3)

The information processing apparatus according to (2), wherein

the correction unit performs outlier processing on the processing-target image before the noise reduction correction.

(4)

The information processing apparatus according to any one of (1) to (3), wherein

the guide image generation unit performs image processing after summing up the plurality of images and performing a division on the result.

(5)

The information processing apparatus according to any one of (1) to (3), wherein

the guide image generation unit performs image processing after summing up the plurality of images and before performing the division on the result.

(6)

The information processing apparatus according to any one of (1) to (3), wherein

the guide image generation unit performs processing of zeroing out a pixel equal to or less than a predetermined positive threshold on the plurality of images before summing up the plurality of images.

(7)

The information processing apparatus according to (6), wherein

the guide image generation unit performs the processing of zeroing out the pixel equal to or less than the predetermined positive threshold on the plurality of images, and performs image processing after summing up the plurality of images and performing the division on the result.

(8)

The information processing apparatus according to (6), wherein

the guide image generation unit performs the processing of zeroing out the pixel equal to or less than the predetermined positive threshold on the plurality of images, and performs image processing after summing up the plurality of images and before performing the division on the result.

(9)

The information processing apparatus according to any one of (1) to (3), wherein

the guide image generation unit sums up only images corresponding to a specific cell tumor out of the plurality of images.

(10)

The information processing apparatus according to (9), wherein

the guide image generation unit performs image processing after summing up only the images corresponding to the specific cell tumor out of the plurality of images and performing the division on the result.

(11)

The information processing apparatus according to (9), wherein

the guide image generation unit performs image processing after summing up only the images corresponding to the specific cell tumor out of the plurality of images and before performing the division on the result.

(12)

The information processing apparatus according to (9), wherein

the guide image generation unit performs zero-filling processing of zeroing out a pixel equal to or less than a predetermined positive threshold on the images corresponding to the specific cell tumor out of the plurality of images, and sums up only the images corresponding to the specific cell tumor after the zero-filling processing.

(13)

The information processing apparatus according to (12), wherein

the guide image generation unit performs image processing after summing up only the images corresponding to the specific cell tumor after the zero-filling processing and performing the division on the result.

(14)

The information processing apparatus according to (12), wherein

the guide image generation unit performs image processing after summing up only the images corresponding to the specific cell tumor after the zero-filling processing and before performing the division on the result.

(15)

The information processing apparatus according to any one of (1) to (14), wherein

the guide image generation unit sums up the plurality of images using an analysis result for a processing-target image as a weight.

(16)

The information processing apparatus according to (15), wherein

the guide image generation unit repeatedly sums up the plurality of images using the analysis result as the weight until the analysis result becomes comparable to an analysis result of a comparison target.

(17)

The information processing apparatus according to any one of (1) to (16), wherein

the plurality of images is each a color-separated image.

(18)

The information processing apparatus according to (4), (5), (7), (8), (10), (11), (13) or (14), wherein

the guide image generation unit performs the image processing using a noise removal filter and an edge enhancement filter.

(19)

A biological sample observation system comprising:

an image-capturing device configured to acquire a plurality of images each including spectral information regarding a biomarker; and

an information processing apparatus configured to process the plurality of images, wherein

the information processing apparatus includes

a guide image generation unit configured to sum up the plurality of images and perform a division on a result by a number of summed images to generate a guide image for correction.

(20)

An image generation method comprising:

summing up a plurality of images each including spectral information regarding a biomarker, and performing a division on a result by a number of summed images to generate a guide image for correction.

(21)

A biological sample observation system including the information processing apparatus according to any one of (1) to (18).

(22)

An image generation method of generating an image using the information processing apparatus according to any one of (1) to (18).

### REFERENCE SIGNS LIST

1 OBSERVATION UNIT
2 PROCESSING UNIT
3 DISPLAY UNIT
10 EXCITATION UNIT
10A FLUORESCENT REAGENT
11A REAGENT IDENTIFICATION INFORMATION
20 STAGE
20A SPECIMEN
21 MEMORY UNIT
21A SPECIMEN IDENTIFICATION INFORMATION
22 DATA CALIBRATION UNIT
23 IMAGE FORMATION UNIT
30 SPECTROSCOPIC IMAGING UNIT
30A FLUORESCENT-STAINED SPECIMEN
40 OBSERVATION OPTICAL SYSTEM
50 SCANNING MECHANISM
60 FOCUSING MECHANISM
70 NON-FLUORESCENT OBSERVATION UNIT
80 CONTROL UNIT
100 INFORMATION PROCESSING APPARATUS
110 ACQUISITION UNIT
111 INFORMATION ACQUISITION UNIT
112 IMAGE ACQUISITION UNIT
120 STORAGE UNIT
121 INFORMATION STORAGE UNIT
122 IMAGE INFORMATION STORAGE UNIT
123 ANALYSIS RESULT STORAGE UNIT
130 PROCESSING UNIT
131 ANALYSIS UNIT
132 IMAGE GENERATION UNIT
133 GUIDE IMAGE GENERATION UNIT
134 CORRECTION UNIT
140 DISPLAY UNIT
150 CONTROL UNIT
160 OPERATION UNIT
200 DATABASE
500 FLUORESCENCE OBSERVATION APPARATUS
1311 CONCATENATION UNIT
1321 COLOR SEPARATION UNIT
1321a FIRST COLOR SEPARATION UNIT
1321b SECOND COLOR SEPARATION UNIT
1322 SPECTRAL EXTRACTION UNIT
5000 MICROSCOPE SYSTEM
5100 MICROSCOPE EQUIPMENT
5101 LIGHT IRRADIATION UNIT
5102 OPTICAL UNIT
5103 SIGNAL ACQUISITION UNIT
5104 SAMPLE PLACEMENT UNIT
5110 CONTROL UNIT
5120 INFORMATION PROCESSING UNIT

1. An information processing apparatus comprising:
a guide image generation unit configured to sum up a plurality of images each including spectral information regarding a biomarker, and perform a division on a result by a number of summed images to generate a guide image for correction.

2. The information processing apparatus according to claim 1, further comprising:
a correction unit configured to perform noise reduction correction on a processing-target image using the guide image.

3. The information processing apparatus according to claim 2, wherein
the correction unit performs outlier processing on the processing-target image before the noise reduction correction.

4. The information processing apparatus according to claim 1, wherein
the guide image generation unit performs image processing after summing up the plurality of images and performing a division on the result.

5. The information processing apparatus according to claim 1, wherein
the guide image generation unit performs image processing after summing up the plurality of images and before performing the division on the result.

6. The information processing apparatus according to claim 1, wherein
the guide image generation unit performs processing of zeroing out a pixel equal to or less than a predetermined positive threshold on the plurality of images before summing up the plurality of images.

7. The information processing apparatus according to claim 6, wherein
the guide image generation unit performs the processing of zeroing out the pixel equal to or less than the predetermined positive threshold on the plurality of images, and performs image processing after summing up the plurality of images and performing the division on the result.

8. The information processing apparatus according to claim 6, wherein
the guide image generation unit performs the processing of zeroing out the pixel equal to or less than the predetermined positive threshold on the plurality of images, and performs image processing after summing up the plurality of images and before performing the division on the result.

9. The information processing apparatus according to claim 1, wherein
the guide image generation unit sums up only images corresponding to a specific cell tumor out of the plurality of images.

10. The information processing apparatus according to claim 9, wherein
the guide image generation unit performs image processing after summing up only the images corresponding to the specific cell tumor out of the plurality of images and performing the division on the result.

11. The information processing apparatus according to claim 9, wherein
the guide image generation unit performs image processing after summing up only the images corresponding to the specific cell tumor out of the plurality of images and before performing the division on the result.

12. The information processing apparatus according to claim 9, wherein
the guide image generation unit performs zero-filling processing of zeroing out a pixel equal to or less than a predetermined positive threshold on the images corresponding to the specific cell tumor out of the plurality of images, and sums up only the images corresponding to the specific cell tumor after the zero-filling processing.

13. The information processing apparatus according to claim 12, wherein
the guide image generation unit performs image processing after summing up only the images corresponding to the specific cell tumor after the zero-filling processing and performing the division on the result.

14. The information processing apparatus according to claim 12, wherein
the guide image generation unit performs image processing after summing up only the images corresponding to the specific cell tumor after the zero-filling processing and before performing the division on the result.

15. The information processing apparatus according to claim 1, wherein
the guide image generation unit sums up the plurality of images using an analysis result for a processing-target image as a weight.

16. The information processing apparatus according to claim 15, wherein
the guide image generation unit repeatedly sums up the plurality of images using the analysis result as the weight until the analysis result becomes comparable to an analysis result of a comparison target.

17. The information processing apparatus according to claim 1, wherein
the plurality of images is each a color-separated image.

18. The information processing apparatus according to claim 4, wherein
the guide image generation unit performs the image processing using a noise removal filter and an edge enhancement filter.

19. A biological sample observation system comprising:
an image-capturing device configured to acquire a plurality of images each including spectral information regarding a biomarker; and
an information processing apparatus configured to process the plurality of images, wherein
the information processing apparatus includes
a guide image generation unit configured to sum up the plurality of images and perform a division on a result by a number of summed images to generate a guide image for correction.

20. An image generation method comprising:
summing up a plurality of images each including spectral information regarding a biomarker, and performing a division on a result by a number of summed images to generate a guide image for correction.
